(19) United States
(12) Patent Application Publication
(10) Pub. No.: US 2020/0345021 A1
(43) Pub. Date: Nov. 5, 2020

(54) METHOD AND SYSTEM FOR ENHANCING THE EFFICACY USING IONIZED/AEROSOLIZED HYDROGEN PEROXIDE IN REDUCING MICROBIAL POPULATIONS, METHOD OF USE THEREOF

(71) Applicant: TOMI Environmental Solutions, Inc., Frederick, MD (US)

(72) Inventor: Halden Stuart SHANE, Beverly Hills, CA (US)

(21) Appl. No.: 16/864,523

(22) Filed: May 1, 2020

Related U.S. Application Data
(60) Provisional application No. 62/842,207, filed on May 2, 2019.

(51) Int. Cl. A23B 7/152; A01N 59/00; A23L 3/26; A23L 3/3445

(52) U.S. Cl. CPC A23B 7/152; A01N 59/00; A23V 2002/00; A23L 3/3445; A23L 3/26

(57) ABSTRACT

Systems and methods of decontaminating food substances by using cold plasma to enhance the performance of ionized hydrogen peroxide to decontaminate food, and methods of use thereof. Cold plasma activation significantly enhanced the efficacy of hydrogen peroxide (HO₂) mist against bacteria on fresh produce, and the technology may be used to enhance microbial safety. Cold plasma activated ionized hydrogen peroxide (iHP) can be applied on various fresh produce items. In particular, cold plasma enhanced the efficacy of hydrogen peroxide (H₂O₂) mist against Salmonella and Liberia.

This application claims priority from U.S. Provisional Application No. 62/842,207. filed May 2, 2019, which is incorporated by reference.

### FIELD

This application generally relates to the field of agriculture, food decontamination, in particular, decontamination using ionized/aerosolized hydrogen peroxide.

### BACKGROUND

The microbial safety of fresh produce remains a worldwide concern Fresh fruits and vegetables such as leafy greens, tomatoes and melons are increasingly implicated in outbreaks of foodborne illnesses. Among the human pathogens of concern are Salmonella spp. Escherichia coli O157:H7 and Listeria monocytogenes. Controlling and destroying these pathogenic microorganisms in foods remains a formidable challenge. The present application addresses methods and systems of addressing this challenge.

### SUMMARY

An aspect of the application is directed to a method for decontaminating a fresh produce, comprising the steps of: entering input parameters of the fresh produce into a processing unit, wherein the processing unit is programmed to determine fluid properties of a decontamination fluid in an ionization/aerosolization and activation device based on the input parameters of the space around the fresh produce, activating a decontamination cycle of the ionization/aerosolization and activation device, wherein the decontamination cycle comprises the steps of: providing a reservoir of the decontamination fluid, setting the determined fluid properties of the decontamination fluid; generating a very dry mist comprising ionized hydrogen peroxide of the decontamination fluid, wherein an ionized/aerosolized mist of hydrogen peroxide is passed through a cold plasma arc, and wherein the generated very dry mist is applied to decontaminate the fresh produce and surrounding space.

In certain embodiments, the ionization/aerosolization and activation device is operated manually. In particular embodiments, the ionization/aerosolization and activation device is hand-held.

In certain embodiments, the input parameters of the fresh produce comprise, dimensions of the fresh produce, a position of the ionization/aerosolization and activation device relative to boundaries of the fresh produce, air temperature, pressure, and humidity of the fresh produce. In particular embodiments, the set fluid properties of the decontamination fluid comprise air pressure and fluid flow rate. In other embodiments, the setting of the determined fluid properties to the decontamination fluid is performed by controlling an air valve. In certain embodiments, the air valve is controlled by programming the processing unit to control a potentiometer. In various embodiments, the determined fluid properties of the decontamination fluid are adjusted by a size and a shape of a tube located at an exit of the decontamination fluid out of the ionization/aerosolization and activation device.

In particular embodiments, the fluid properties of the decontamination fluid are set by lowering the air pressure and the fluid flow rate respectively below a predetermined standard air pressure and a predetermined standard fluid flow rate

In other embodiments, input parameters of a target area are entered into a processing unit, wherein the processing unit is further programmed to determine the fluid properties of the decontamination fluid in the ionization/aerosolization and activation device based on the input parameters of the target area. The input parameters of the fresh produce may be manually input. The input parameters of the fresh produce are measured by a plurality of sensors that are in networked communication with the processing unit.

In particular embodiments, the processing unit and the ionization/aerosolization and activation device are in wireless communication.

Another aspect of the application is a system for decontaminating a fresh produce, comprising an ionization/aerosolization and activation device and a computer processor, wherein the computer processor is in networked communication with the ionization/aerosolization and activation device, wherein input parameters of the fresh produce are entered into the computer processor, wherein the computer processor is programmed to determine fluid properties of a decontamination fluid in the ionization/aerosolization and activation device based on the input parameters of the fresh produce, wherein the computer processor is further programmed to activate a decontamination cycle of the ionization/aerosolization and activation device, the decontamination cycle comprising the steps of: providing a reservoir of the decontamination fluid; setting the determined fluid properties of the decontamination fluid; generating a very dry mist of the decontamination fluid, wherein an ionized/aerosolized mist of hydrogen peroxide is passed through a cold plasma arc. and wherein the generated ionized very dry mist is applied to decontaminate the fresh produce.

These and oilier aspects and embodiments of the present application will become better understood with reference to the following detailed description when considered in association with the accompanying drawings and claims.

### BRIEF DESCRIPTION OF THE DRAWINGS

FIG. 1 depicts an embodiment of an ionization/aerosolization and activation device 100 operable manually as a hand-held device and programmable for automated operation.

FIG. 2 depicts an embodiment of a display of a programming clock 201 regulating fluid properties of a fluid applied by an ionization/aerosolization and activation device

FIG. 3 shows introduction of ionized/aerosolized H₂O₂ into a treatment chamber containing tomatoes (left) and close up of the ionization/aerosolization and activation delivering device (right).

FIG. 4 shows size distribution of droplets in the treatment chamber immediately after the introduction of ionized/aerosolized hydrogen peroxide (H₂O₂) and after additional 30 min dwell time.

Throughout the drawings, the same reference numerals and characters, unless otherwise stated are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and appended claims

### DETAILED DESCRIPTION

Reference will be made in detail to certain aspects and exemplary embodiments of the application, illustrating examples in the accompanying structures and figures. The aspects of the application will be described in conjunction with the exemplary embodiments, including methods, materials arid examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described

Unless defined otherwise, all technical and scientific terms used herein have the same meanings as commonly understood by one of skill in the art to which the disclosed method and compositions belong. It must be noted that as used herein and in the appended claims, the singular forms “a,” “an,” and “the” include plural reference unless the context clearly dictates otherwise. Thus, for example, reference to “a peptide” includes “one or more” peptides or a “plurality” of such peptides.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it w ill be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to “the value,” greater than or equal to the value” and possible ranges between values are also disclosed, as appropriately understood by the skilled artisan. For example, if the value “10” is disclosed the “less than or equal to 10” as well as “greater than or equal to 10” is also disclosed.

Definitions

“Fresh produce” means farm-produced crops, including fruits and vegetables (e.g., grains, oats, etc.), in which they are in a state of being fresh (generally in the same state as where and when they were harvested). Fresh produce includes, for example, fresh apples, oranges, bananas, cantaloupes, tomatoes, kale, lettuce, carrots, onions, sweetcorn, melons, plantains, etc.

“Ionization” is defined as the ability to convert an atom, molecule, or substance into an ion or ions typically by removing one or more electrons. “Aerosolizatiou” is defined as the dispersion of a liquid material into the air or a solution in the form of fine mist, usually for therapeutic and sanitary purposes. “Cold plasma” is a sanitizing technology in the field of food processing in which plasma has many gas-like qualities, although it is technically a distinct state of matter. As additional energy is added, the intra-atomic structures of the components of the gas break down, yielding plasmas-concentrated collections of ions, radical species, and free electrons.

As used herein, the term “decontaminating” or “decontamination” means acting to neutralize or remove pathogens from an area or article. As used herein, the term “pathogen” includes, but is not limited to, a bacterium, yeast, protozoan, virus, or other pathogenic microorganisms. The term “pathogen” also encompasses targeted bioterror agents.

As used herein, the term “bacteria” shall mean members of a large group of unicellular microorganisms that have cell walls hut lack organelles and an organized nucleus. Synonyms for bacteria may include the terms “microorganisms”, “microbes”, “germs”, “bacilli”, and “prokaryotes.” Exemplary bacteria include, hut are not limited to Mycobacterium species, including M. tuberculosis, Staphylococcus species, including S. epidermidis, S. aureus, and methicillin-resistant S. aureus; Streptococcus species, including S. pneumoniae, S. pyogenes, S. mutans, S. agalactiae, S. equi, S. canis, S. bovis, S. equinus, S. anginosus, S. sanguis, S. salivarins, S. mitis; other pathogenic Streptococcal species, including Enterococcus species, such as E. faecalis and E. faecium; Haemophilus influenzae, Pseudomonas species, including P. aeruginosa, P. pseudomallei, and P. mallei; Salmonella species, including S. enterocolitis, S. typhimurium, S. enteritidis, S. bongori, and S. choieraesuis; Shigella species, including S. flexrieri, S. sonnei, S. dysenteriae, and S. boydii, Brucella species, including B. melitensis, B. suis, B. abortus, and B. pertussis; Neisseria species, including N. meningitidis and N. gonorrhoeae; Escherichia coli, including enterotoxigenic E. coli (ETEC); Vibrio cholerae, Helicobacter pylori, Geobacillus stearothermophilus, Chlamydia trachomatis, Clostridium difficile, Cryptococcus neoformans, Moraxella species, including M. catarrhalis, Campylobacter species, including C. jejuni; Corynebacterium species, including C. diphtherias, C. ulcerans, C. pseudotuberculosis, C. pseudodiphtheriticum, C. urealyticum, C. hemolyticum, C. equi; Listeria monocytogenes, Nocardia asteroides, Bacteroides species, Actinomycetes species, Treponema pallidum, Leptospirosa species. Klebsiella pneumoniae; Proteus sp., including Proteus vulgaris; Serratia species, Acinetobacter, Yersinia species including Y. pestis and Y. pseudotubercubsis; Francisella tularensis, Enterobacter species, Bacteriodes species, Legionella species, Borrelia burgdorferi, and the like. As used herein, the term “targeted bioterror agents” includes, but is not limited to, anthrax (Bacillus antracis), plague (Yersinia pestis), and tularemia (Franciscella tularensis).

As used herein, the term “fungi” shall mean any member of the group of saprophytic and parasitic spore-producing eukaryotic typically filamentous organisms formerly classified as plants that lack chlorophyll and include molds, rusts, mildews, smuts, mushrooms, and yeasts. Exemplary fungi include, but are not limited to, Aspergillus species, Dermatophytes, Blastomyces derinatitidis, Candida species, including C. auris, C. albicans and C. krusei; Malassezia furfur, Exophiala werneckii Piedraia hortai, Trichosporon beigelii, Pseudallescheria boydii, Madurella grisea, Histoplasma capsulatum, Sporothrix schenckii, Histoplasma capsulatum, Tinea species, including T. versicolor, T. pedis T. unguium, T. cruris, T. capitus, T. corporis, T. barbae; Trichophyton species, including T. rubrum, T. interdigitale. T. tonsurans. T. violaceum, T. yaoundei, T. schoenleinii, T. megainii, T. soudanense, T. equinum, T. erinacei, and T. verrucosum; Mycoplasma genitalia: Microsporum species, including M. audouini, M. femigineum, M. canis, M. nanum, M. distortum, M. gypseum, M. fulvum, and the like.

As used herein, the term “protozoan” shall mean any member of a diverse group of eukaryotes that are primarily unicellular, existing singly or aggregating into colonies, are usually nonphotosynthetic, and are often classified further into phyla according to their capacity for and means of motility, as by pseudopods, flagella, or cilia. Exemplary protozoans include, but are not limited to Plasmodium species, including P. falciparum, P. vivax, P. ovale, and P. malariae; Leishmania species, including L. major, L. tropica, L. donovani, L. infantum, L. chagasi, L. mexicana, L. panamensis, L. braziliensis and L. guyanensi; Cryptosporidium, Isospora belli, Toxoplasma gondii, Trichomonas vaginalis, and Cyclospora species.

As used herein, the term “Viru” can include, but is not limited to, plant viruses, influenza viruses, herpesviruses, polioviruses, noroviruses, and retroviruses. Examples of viruses include, but are not limited to human and plant viruses. Human contaminant viruses may include, but are not limited to human immunodeficiency virus type 1 and type 2 (HIV-1 and HIV-2), human T-cell lymphotropic virus type I and type II (HTLV-I and HTLV-II), hepatitis A virus, hepatitis B virus (HBV), hepatitis C virus (HCV). hepatitis delta virus (HDV), hepatitis E virus (HEV) hepatitis G virus (HGV), parvovirus B19 virus, hepatitis A virus, hepatitis G virus, hepatitis E virus, transfusion transmitted virus (TTV), Epstein-Barr virus, human cytomegalovirus type 1 (HCMV-1), human herpesvirus type 6 (HHV-6), human herpesvirus type 7 (HHV-7), human herpesvirus type 8 (HHV-8), influenza type A viruses, including subtypes H1N1 and H5N1, human metapneumovirus, severe acute respiratory syndrome (SARS) coronavirus, SARS-CoV-2, Middle East respiratory syndrome (MERS). hantavirus, and RNA viruses from Arenaviridae (e.g., Lassa fever virus (LFV)). Pneumoviridae (e.g., human metapneumovirus), Filoviridae (e.g., Ebola virus(EBOV), Marburg virus (MBGV) and Zika virus); Bunyaviridae (e.g., Rift Valley fever virus (RVFV), Crimean-Congo hemorrhagic fever virus (CCHFV), and hantavirus); Flaviviridae (West Nile virus (WNV). Dengue fever virus (DENV), yellow fever virus (YFV), GB virus C (GBV-C: formerly known as hepatitis G virus (HGV)); Rotaviridae (e.g., rotavirus), and combinations thereof.

As used herein, the term “decontamination fluid” refers to the source of an active species used to reduce microbial populations on fresh produce. The preferred active species is hydroxyl ions, and the preferred source is hydrogen peroxide. The source may instead be a more-complex species that produces hydroxyl ions upon reaction or decomposition. Examples of such more-complex species include peracetic acid (CH₂COO—OH+H₂O), sodium percarbonate (2Na2CO₃+3H₂O₂), and glutaraldehyde (CH₈O₂). The decontamination fluid may further include promoting species that aid the active species in accomplishing its attack upon the biological microorganisms. Examples of such promoting species include ethylenediaminetetraacetate, isopropyl alcohol, enzymes, fatty acids, and acids The decontamination fluid is of any operable type. The decontamination fluid must contain an activatable species. A preferred decontamination fluid comprises a source of hydroxyl ions (OH⁻) for subsequent activation. Such a source may be hydrogen peroxide (H₂O₂) or a precursor species that produces hydroxyl ions. Other sources of hydroxyl ions may be used as appropriate. Examples of other operable sources of hydroxyl ions include peracetic acid (CH₂COO—OH+H₂O), sodium percarbonate (2Na₂CO₃+3H₂O₂). and glutaraldehyde (CH₈O₂). Other activatable species and sources of such other activatable species may also be used. In some embodiments, activated ionic particles are generated by passing Water for Injection (WFI) through the arc, providing greater than 3-log¹⁰ killing of bacteria, bacterial spores, or virus particles relative to untreated controls.

The decontamination fluid may also contain promoting species that are not themselves sources of activatable species such as hydroxyl ions, but instead modify the decontamination reactions in some beneficial fashion. Examples include ethylenediaminetetraacetate (EDTA), which binds metal ions and allows the activated species to destroy the cell walls more readily; an alcohol such as isopropyl alcohol which improves wetting of the mist to the cells; enzymes, which speed up or intensity the redox reaction in which the activated species attacks the cell walls; fatty acids, which act as an ancillary anti-microbial and may combine with free radicals to create residual anti-microbial activity; and acids such as citric acid, lactic acid, or oxalic acid, which speed up or intensity the redox reaction and may act as ancillary anti-microbial species to pH-sensitive organisms. Mixtures of the various activatable species and the various promoting species may be used as well. The decontamination fluids are preferably aqueous, but may be solutions in organics such as alcohol. The decontamination fluid source may be a source of the decontamination fluid itself, or a source of a decontamination fluid precursor that chemically reacts or decomposes to produce the decontamination fluid.

One of the prime challenges for food decontamination technology is the decontamination of food without a fleeting either taste or fresh appearance of the food. The decontamination technology herein provides a substantial advantage over other decontamination approaches since the by-product of the decontamination process is simply water. The use of hydroxyl ions herein is effective against DNA molecules of contaminants as lire hydroxyl ions react with close-by organics causing chain oxidation and destruction of DNA molecules as well as cellular membranes and other cell components.

The decontamination methods herein also help prevent unwanted browning of fresh produce. Enzymatic browning is considered a secondary loss during post-harvest handling and storage, which results in spoiling of the fresh produce. Endogenous enzymes such as polyphenoloxidase and peroxidase are primary causes of enzymatic browning due to oxidization of phenols at the expense of hydrogen peroxide leading to off flavors. These enzymes can be inactivated through oxidation reactions mediated by hydroxyl ions.

The food decontamination methods herein also are effective in decontamination of food packaging materials, such as plastic bottles, lids and films without adversely affecting the properties of the material or leaving any residues.

In certain embodiments, the food for decontamination is placed at a physically separate location from the point of generation of the dry mist of hydroxyl ions generated by the decontamination device, such that the dry mist must travel a certain range before reaching the surface of the food. These embodiments are known as remote treatment. In other embodiments, the food for decontamination is placed near to the point of generation of the dry mist of hydroxyl ions, such that the dry mist is administered directly to the surface of the food with virtual immediacy after generation of the hydroxyl ions These embodiments are known as direct treatment. In particular embodiments, the dry mist of hydroxyl ions is produced in a series of pulses from the decontamination device.

In general embodiments, the methods of decontamination described herein are performed at one atmosphere (1 bar, 100 kPa) and do not require air-tight vacuum chambers, etc. Therefore, fresh produce material can be processed by movement through a treatment/one by a conveyor. The decontamination devices may rely on standard commercial electrical DC or AC current.

In one embodiment, harvested fresh produce, e.g., fruit, vegetables, etc., are placed on a conveyor belt. The conveyor belt extends into a decontamination chamber, which has an entrance and an exit for the conveyor belt The decontamination chamber is sufficiently large to encompass both the conveyor belt and any fresh produce placed upon the conveyor belt. The conveyor belt is switched on once the fresh produce intended for decontamination is placed upon it. The conveyor belt then transports the fresh produced inside the decontamination chamber through the entrance to the decontamination chamber. Once the fresh produce is wholly contained within the inner space of the decontamination chamber, the conveyor belt is stopped, so that the fresh produce now sits within the inner space ready for decontamination The decontamination chamber may be equipped with one or more decontamination devices which will generate a dry mist of hydroxyl ions as described herein for decontamination of the fresh produce. The dry mist is as described herein for decontamination of pathogens, such as viruses, bacteria, fungi, microbes of all sorts, etc.

In various embodiments, the position of the one or more decontamination devices within the decontamination chamber can be varied. In certain embodiments, one decontamination device is place on the roof of the decontamination chamber in a central position. The centrally positioned decontamination device on the roof of the chamber may then have a rotatable spray head so that the dry mist produced by the device can be sprayed in a 360° radius within the decontamination chamber In another embodiment, in addition to a centrally positioned decontamination device on the roof of the chamber, further decontamination devices can he placed at each of the four roof comers of the decontamination chamber. Each of the decontamination devices positioned at the four roof comers of the decontamination chamber may have either a rotatable spray head or a fixed angle spray head. In the cases where a fixed angles spray head is used the angle is preferentially aimed downwards and towards the center of the conveyor belt within the decontamination chamber. The rotation of the spray heads of decontamination devices is controlled by a computer system as described herein. The movements of spray heads may be coordinated collectively or individually, e.g., raising and lowering the vertical angle of the spray head or rotating the spray head through a radial direction.

In certain embodiments, the decontamination chamber may be designed to allow the spray heads of the decontamination devices to shift locations within the chamber. For example, a decontamination device on the roof of the decontamination chamber may be designed to shift position so that it produces a dry mist beginning from a series of different positions on the roof of the chamber. The decontamination device may be controlled by a computer systems as described herein to shift position on the roof of the chamber in a grid-like pattern In another example, decontamination devices that are positioned at the roof corners of the decontamination chamber may be designed to move their position lower, so that the point of generation of a dry mist by their spray head is lowered to be aligned with the conveyor belt, or from an intermediate position between the base of the conveyor belt and the roof of the decontamination chamber. The movement of the spray heads in the corners of the decontamination chamber along a vertical axis can be coordinated collectively or individually, and controlled by the computer system as described herein.

In certain embodiments, one or more decontamination devices are in fixed positions on the roof chamber, so that the spray beads of the devices which produce a dry mist of hydroxyl ions are arranged in a grid pattern on the roof of the chamber. In cases where one or more decontamination devices are in fixed positions on the roof of the decontamination chamber, each of the devices may have a rotatable spray head. In certain instances, one or more spray heads producing the dry mist may be lowered directly from the roof of the chamber towards the conveyor belt on which the fresh produce to be decontaminated rests. For example, a decontamination device with a spray head may be located in a fixed position at the center of the roof of the decontamination chamber; the spray head of the device may be lowered via the use of a rod, or other suitable mechanically automated extension, so the spray head is brought closer to the fresh produce resting upon the conveyor belt.

In particular embodiments, one or more decontamination devices may be installed in the base of the decontamination chamber either underneath the conveyor bell or to either side of the conveyor belt upon which fresh produce rests. For example, a decontamination device with a spray head to produce dry mist of hydroxyl ions as described herein can be positioned in a flanking position to the conveyor belt. In cases where a spray head has a flanking position, the angle of the point of generation of the dry mist by the spray head is preferentially rotatable both radially and vertically, so that the dry mist can be produced at a variety of angles to the fresh produce sitting on the conveyor belt. In certain cases, a flanking spray head can be moved in position upward, so that its positions rises or lowers relatives to the conveyor belt upon which the fresh produce rests. In cases where a decontamination device is positioned beneath the conveyor belt, the conveyor belt is made of a mesh, or suitable weave, that will allow the dry mists to pass through the mesh, or weave, to teach the fresh produce sitting on the upper side of the conveyor belt.

In certain embodiments, the conveyor belt may have one or more rotatable discs placed upon it, and the fresh produce sits upon the rotatable discs. The rotatable discs allow the fresh produce to be turned as the dry mist is administered by the decontamination devices within the decontamination chamber as described above.

In certain instances, the fresh produce on the conveyor belt may contained in crates which have suitable lattice work to allow exposure of the fresh produce within the crates. In certain cases, the crate may contain within subdivisions into which one or more items of fresh produce have been placed (e.g., apples, oranges, etc.).

In certain embodiments, the fresh produce may be placed as individual items on the conveyor belt and the individual items will have a dry mist of hydroxyl ions administered as described herein.

In certain embodiments, the decontamination chamber may include a light fan for drying the fresh produce after administration of the dry mist as described herein. In certain cases, the conveyor belt may exit the decontamination chamber and then enter a drying chamber, so that the fresh produce can be dried before further transportation.

In certain embodiments, the decontamination chamber is a temporary structure (e.g., a tent) that may be assembled around a conveyor belt upon which fresh produce rests. In some cases, where the decontamination chamber is a temporary structure the spray heads of decontamination devices are in fixed position relative to the fresh produce as described herein.

In some embodiments, the decontamination chamber attaches to the conveyor belt and moves with the fresh produces during the decontamination process. In some embodiments, the decontamination chamber itself is mounted on a convey belt so that it moves with the fresh produces during the decontamination process.

In certain embodiments, instead of being carried by conveyor belt into a decontamination chamber, the fresh produce may be resting on a table, which may either be wheeled inside the decontamination chamber, or be in a fixed position within the decontamination chamber already. In certain instances, the fresh produce is carried into the decontamination chamber on a cart, where the cm has a suitable lattice structure to allow the thy mist of hydroxyl ions to reach the surfaces of the fresh produce.

In certain embodiments, the decontamination chamber may be contained within a can and fresh produce may be placed within the chamber on the cart for decontamination.

In certain embodiments, the decontamination chamber may be part of a vehicle for transportation of fresh produce and the decontamination of the fresh produce may occur within the vehicle while the vehicle is transporting the fresh produce.

In certain instances, the decontamination chamber may be filled with a dry mist of hydroxyl ions prior to the entry of fresh produce to the decontamination chamber. In such instances, the conveyor belt transports the fresh produce into the chamber, where the fresh produce then slowly moves through the dry mist In such instances, the fresh produce may be rotated (such as by placement on a rotatable disc) as the fresh produce moves through the decontamination chamber.

In a particular embodiment, the fresh produce may be transported on a conveyor belt that is sloping or at an angle as it moves through the decontamination chamber. In other embodiments, the conveyor belt may be designed to shake the produce (without bruising), so that differing surfaces are exposed to the dry mist of hydroxyl ions as the fresh produce moves through the decontamination chamber.

In certain embodiments, where, far example, the fresh produce may be relatively hard-cased (e.g., peanuts), the conveyor belt may be designed to transport the fresh produce to a decontamination which is designed to permit the produce to enter the chamber by falling or sliding through the entrance to the chamber. In such cases, preferentially the chamber is already filled with a dry mist of hydroxyl ions.

In certain embodiments, the fresh produce may be transported into the decontamination chamber by a first conveyor belt, but transported out of the decontamination chamber by a separate second conveyor belt. In such cases, the second separate conveyor belt is positioned so that the second conveyor belt begins below the end of the first conveyor belt. The distance between the end of the first conveyor belt and the beginning of the second conveyor belt is minimized so that the fall experienced by fresh produce from the first conveyor belt to the second conveyor belt is also minimized. Preferentially, the intersection of the first and second conveyor belts is designed to that fresh produce rolls from the first or the second conveyor belt without risk bruising. In such cases, decontamination devices are positioned flanking the point of intersection between the conveyor belts, such that the dry mist of hydroxyl ions produced by the spray heads of the decontamination devices will be administered to the fresh produce as it rolls from the first conveyor belt to the second conveyor belt. In this manner, undersides and other covered sides of the fresh produce are exposed to the dry mist without risk of bruising. In such cases, the conveyor belt may also be made of a mesh or a weave as described herein to further minimize risk of bruising and maximize exposure of the surfaces of the fresh produce to the dry mist. In further embodiments, more conveyor belts may be added stepwise within the decontamination chamber so that third, fourth, fifth, etc., rolls may occur while the fresh produce is exposed to the dry mist.

The decontamination chamber containing one or more conveyor belts may be already filled with dry mist of hydroxyl ions prior to entry of the fresh produce, or the dry mist may be sprayed in a series of cycles, such as pulsed cycles, while the fresh produce is within the chamber. The multiple conveyor belts within the chamber may also be stopped so that fresh produce may move through the chamber in a sequential manner, resting in place on one conveyor belt, rolling into the next conveyor belt, being held in place on that conveyor belt, rolling to the next one, etc. The sequence of cycles of dry mists, movement of spray heads of decontamination devices, and movements of the conveyor belts nay be controlled and coordinated by a computer system as described herein.

In certain embodiments, two or more decontamination chambers may be arranged sequentially. In such cases, the conveyor belt enters a first decontamination chamber wherein a dry mist of hydroxyl ions is administered as described herein to the fresh produce resting on the conveyor belt. The conveyor belt then exits the first decontamination chamber carrying the fresh produce towards a second decontamination chamber; prior to entering the second decontamination chamber the prior underside of the fresh produce is exposed so that it no longer rests directly on the conveyor belt, but is instead open to the air. The conveyor belt then carries the fresh produce into the second decontamination chamber where it is again exposed to a dry mist of hydroxyl ions as described herein. In this manner, the fresh produce may be turned during the decontamination process without rolling so that all sides of the produce are thoroughly exposed to decontamination by dry mist of hydroxyl ions as described herein.

In certain embodiments, instead of a decontamination chamber, a dry mist of hydroxyl ions is administered directly to the surface of fresh produce by a hand-held decontamination device equipped with a spray head that acts a point of generation for the dry mist of hydroxyl ions.

In other embodiments, a dry mist of hydroxyl ions is administered directly to fresh produce by a decontamination device equipped with a spray head that is part of an airborne drone. In such instances, the drone and its flight pattern may be controlled by computer systems such as those described herein.

In certain embodiments, a dry mist of hydroxyl ions is produced as part of a vertical fanning installation, or other indoor farming installation. In such case, the decontamination methods described herein may be administered as part of system installed within the building in which the farm operations are occurring. In such instances, the dry mist of hydroxyl ions is administered while the fresh produce is grown inside and performs a dual function of both ensuring decontamination of the produce and, since water is a by-product of the process, also contributing desirable hydration to the plants.

Within an interior forming installation, the decontamination process may be controlled by a computer system as described herein which controls cycles of decontamination situated within the building. The decontamination system may be built into the design of the building itself, or installed into buildings that have been converted from other uses to indoor farming. The decontamination methods described herein may also be applicable to greenhouse farming. In certain embodiments, the decontamination device may be designed for home use in a handheld or portable mode and deployed by home gardeners who wish to decontaminate their plants. The decontamination devices may be deployed in a variety of manners to provide support for indoor farming as described herein. Within the context of an indoor farming operation, such as vertical farming, decontamination devices on airborne drones may be used to directly administer the dry mist to plant within the installation. Given that energy costs and pollution arc major challenges in vertical farming, the decontamination methods described herein provide considerable advantages over current methods of both control against pathogens infecting the plants, while complimenting the use of hydroponics or other growth systems without introducing undesirable chemical contaminants.

Method of Decontamination

Methods and technologies preferable for use in decontamination processes are discussed in U.S. Pat. No. 10,391.188, which is incorporated herein by reference. A decontamination fluid mist is activated to produce an activated decontamination fluid mist. The activation produces activated species of the decontamination fluid material in the mist, such as the decontamination fluid material in the ionized, plasma, or free radical states. At least a portion of the activatable species is activated, and in some eases some of the promoting species, if any, is activated. A high yield of activated species is desired to improve the efficiency of the decontamination process, hut it is not necessary that all or even a majority of the activatable species achieve the activated state. Any operable activator may be used. The activator field or beam may be electrical or photonic. Examples include an AC electric field, an AC arc, a DC electric field, a DC arc, an electron beam, an ion beam, a microwave beam, a radio frequency beam, and an ultraviolet light beam produced by a laser or other source. The activator causes at least some of the activatable species of the decontamination fluid in the decontamination fluid mist to be excited to the ion. plasma, or free radical state, thereby achieving “activation”. These activated species enter redox reactions with the cell walls of the microbiological organisms, thereby destroying the cells or at least preventing their multiplication and growth. In the case of the preferred hydrogen peroxide, at least some of the H₂O₂ molecules dissociate to produce hydroxyl (OH⁻) and monotonic oxygen (O⁻) ionic activated species. These activated species remain dissociated for a period of time, typically several seconds or longer, during which they attack and destroy the biological microorganisms. The activator is preferably tunable as to the frequency, waveform, amplitude, or other properties of the activation field or beam, so that it may be optimized for achieving a maximum recombination rime for action against the biological microorganisms. In the case of hydrogen peroxide, the dissociated activated species recombine to form diatomic oxygen and water, harmless molecules.

Ionization/Aerosolization and Activation Device and Control System

An aspect of this application discloses the use of a handheld, point-and-spray device that may be used for reducing microbial populations on fresh produce by using a very dry mist comprising ionized hydrogen peroxide. The handheld device includes a programming clock, and provides air pressure control and fluid flow control through use of one or more potentiometers. The programming clock provides the ability to automate cycles of reducing microbial populations on the fresh produce. The cycles of reducing microbial populations controlled by the programming clock may, for example, include cycles of spraying a very dry mist for thirty seconds, stopping spray for ten seconds, and then re-starting spraying for another thirty seconds, etc, repeating such cycles for a fixed period of time. The programming clock can be set manually by a user or controlled remotely by wireless by the user or a computer processor with pre-programmed decontamination cycles that are transmitted to the device for deployment. In certain embodiments, a user may manually control the cycles of reducing microbial populations by operating by hand the control knob of the device which controls spray of the very dry mist

In certain embodiments, the device will possess a computer processor that can calculate the appropriate settings (e.g., flow rate, air pressure, number and length of decontamination cycles) to produce a very dry mist comprising ionized hydrogen peroxide that will effectively reduce microbial populations on fresh produce. In such embodiments, the user may enter the parameters of the space containing the fresh produce manually to the device, or enter them remotely by a wireless connection. The operation of the device can be fully automated, fully manually controlled, or may be semi-automated (e.g., uses cycles of reducing microbial populations on fresh produce performed automatically according to parameters that have been manually entered).

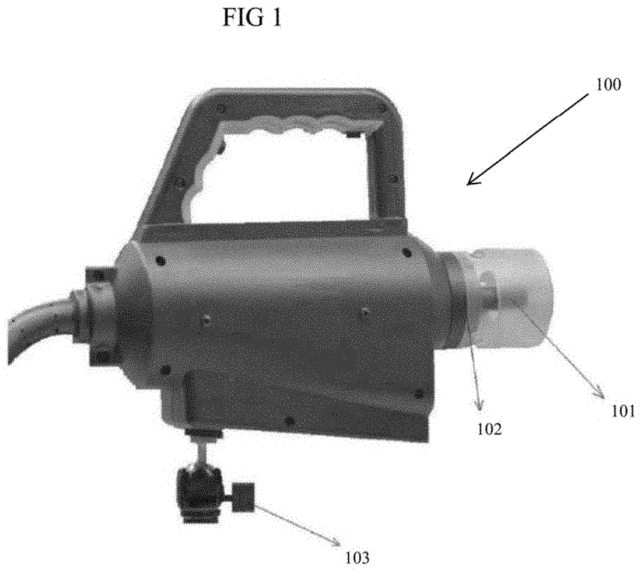

FIG. 1 illustrates one embodiment of a decontamination fluid source, specifically a mist generator 100, which operates on two platforms. One platform may be a handheld, point-and-spray surface ionization/aerosolization and activation device, and the other platform may be a programmable, automated environment ionization/aerosolization and activation device designed reducing microbial populations on fresh produce in particular spaces (e.g., fresh produce on a conveyor belt). The handheld, point-and-spray feature allows for manual or automated control of the decontamination action. The programmable automation may allow input of the surrounding parameters in order to predictably and consistently operate in an optimal arrangement with the geometry of the space containing the fresh produce.

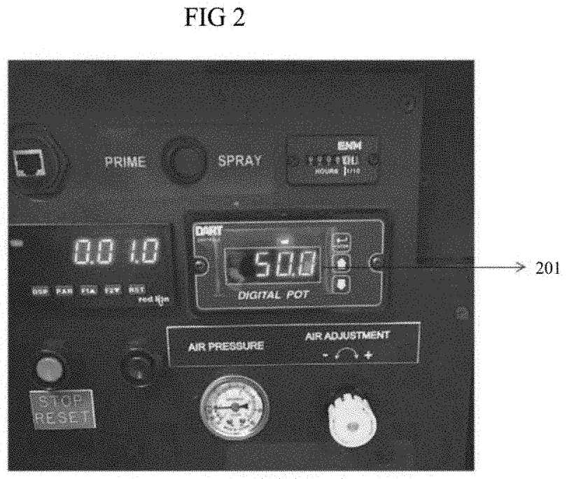

FIG. 2 illustrates one embodiment of a display of a programming clock 101 adjustable to control an ionization/aerosolization and activation device 100 show n in FIG. 1, for example A voltage source within the ionization/aerosolization and activation device may be connected to an adjustable voltage divider, such as a potentiometer, for example. The potentiometer may include a housing that contains a resistive element and a contact that slides along the resistive element, two electrical terminals at the two ends of the resistive element, and a mechanism that moves the sliding contact from one end to the other. The potentiometer used may be a circular slider potentiometer, a liner slider potentiometer, or any other suitable slider arrangement may be used, lire potentiometer tray include a resistive element made of graphite, plastic containing carbon particles, resistance wire, or a mixture of ceramic and metal, for example

The potentiometer may be controlled by a control unit in order to regulate inputs for the electric circuit of the voltage source. The potentiometer may allow a user to control the air pressure and the fluid flow rate of the decontamination fluid mist flowing through a tube 101. While the reduced air pressure affects the size of the produced mist/fog particles, the tube 101 may be modified into a funnel nozzle to compensate for the reduction. The tube's transverse diameter may be gradually varied to allow the spray of the decontamination fluid through the tube 101 to be adjusted in order to produce a desired mist/fog particle size.

The voltage source may be a battery and a circuit to supply a high voltage to an activation source for a sufficient period to activate the amount of decontamination fund that is stored within a pressure container. As mentioned above, the tube 101 may be either foe nozzle of the pressure container or it may be funnel shaped. As shown in FIG. 1, the tube 101 may be attached to the hand-held device 100 operating from a decontamination fluid source and with a plug-in or battery electrical voltage source. The decontamination fluid source may be pressurized to drive the flow of the decontamination fluid through the tube 101, or there may be provided an optional pump that forces the decontamination fluid through the mist generator 100 and out of the tube 101 with greater force.

As shown in FIG. 1, the ionization/aerosolization and activation device 100 may be mounted on a rotating base that allow s better coverage for the area to be decontaminated. The rotating base may be a 180-degree rotating base, or a 360-degree rotating base. In some embodiments, the rotating base is an adjustable rotating base having a rotation range of 60-360 degrees. In some embodiments, the rotation is around a single axis. In other embodiments, the rotation is around multiple axes. In still other embodiments, the rotation is in all directions or is a fully spherical motion. In yet another embodiment, a knob 104 may be applied for manual regulation of the air pressure and fluid flow rate.

In a programmable device, the control unit may be programmed to control the potentiometer and the pump based on the desired fluid parameters For example, in particularly small spaces for reducing microbial populations on fresh produce, a drier mist is generated, in order for the mist to travel a shorter distance. This may be accomplished by reducing the air pressure of the ionization/aerosolization and activation device well below the predetermined standard air pressure, or the standard fluid flow rate well below the predetermined standard flow rate. The standard air pressure entered into the programmable control unit may be in the range between 25-50 psi, and the input standard air pressure range may be modified as deemed suitable. Moreover, the standard fluid flow rate entered into the programmable control unit may be in the range between 25-50 ml/minute, and the input standard fluid flow rate range may be modified as considered appropriate.

In some embodiments, the air pressure of the ionization/aerosolization and activation device may be 5-25 psi, or, in alternative embodiments, it may be 10-20 psi. In one example discussed in detail below, the air pressure of the ionization/aerosolization and activation device is 15 psi. Additionally, in certain embodiments, the flow rate of the decontamination fluid may be 5-25 ml/minute, or, in alternative embodiments, it may be 10-15 ml/minute, in one example discussed in detail below, the flow rate of the decontamination fluid is 10 ml/minute.

In certain embodiments, the spray pattern of a decontamination fluid may be set based on spray cycle parameters, such as a time period during spraying, a time period between two consequent sprayings, and a total number of sprayings performed. In certain embodiments, the time period between two consequent sprayings may be 10-120 seconds, or, in alternative embodiments, it may be 30-90 seconds In one example discussed in detail below, the time period between two consequent sprayings is 60 seconds. Moreover, in certain embodiments, the time period during sprayings may be 10-180 seconds, or, in alternative embodiments, it may be 60-120 seconds. In some cases, the time period during spraying is 90 seconds, with 60 second intervals between spraying.

In comparison with the programmable device, a handheld surface ionization/aerosolization and activation device may be manually operated by turning the control knob on a handheld applicator to produce the ionized hydrogen peroxide very dry mist In one example, fluid or air settings are not programmably modified, but are. instead, manually controlled by the user based on an assessment by the user of the actual confines of the space containing the fresh produce to be decontaminated.

One embodiment of the hand-held ionization/aerosolization and activation device 100 is used in conjunction with a small space containing fresh produce to reduction of microbial populations on the fresh produce. The small space may serve as a chamber in which a target fresh produce is decontaminated The target fresh produce may be stationary, or it may move through the enclosure on a conveyer. The small space may be defined with respect to the device 100 by a variety of characteristics, such as: the dimensions of the space, the relative position of the device 100 from the boundaries of the space, the air temperature/pressure/humidity within the space, or any other property of the space for decontamination deemed relevant. Moreover, in instances where a target fresh produce moves within the space, an initial location of the fresh produce, its relative speed, and its moving direction in regard to the device 100 may be measured to be used as input subsequently. In instances w here the device 100 rotates around a fixed position within the space, the rotation speed may be ascertained and used as input for processing by a computer processor.

The device 100 may be integrated into a system tor reducing microbial populations on fresh produce. The input of the space, and any target fresh produce characteristics, with respect to the device 100 may be entered into the system manually, or it may be measured by multiple sensors. The sensors nay be in networked communication with the computer processor, such as a control unit programmed to control the device 100. The control unit may control an adjustable potentiometer that regulates parameters relevant to the decontamination cycle of the device 100.

In one example, the ionized hydrogen peroxide mist is added to and mixed with another gas flow. The activated decontamination fluid mist mixes with the gas flow, and the mixed gas flow contacts the surface of the fresh produce located within the space for decontamination. Some of the parameters relevant to the performance of the ionization/aerosolization and activation device 190 may he air pressure of the gas that mixes with the mist and fluid flow rate of the fluid departing the device 100. These parameters may be regulated by controlling an air valve 102 placed on the front of the device 100, and/or by modifying the size and shape of the tube 101, for example.

As shown in FIG. 2, the fluid parameters of the ionization/aerosolization and activation device 100 may be monitored on the display of the device. The parameters may be adjusted remotely. In one embodiment, a wireless network connection is feasible between the control unit and the device 100, in order to set the fluid parameters of the device 100. In some embodiments, a wireless connection includes, bet is not limited to, radio frequency, infrared, wifi, BLUETOOTH, or any other suitable means of wireless communication.

The adjustment of the fluid parameters is particularly important in small spaces used for reducing microbial populations on fresh produce. An ionization/aerosolization and activation device 100 allows for manipulation of fluid flow rates and air pressure as needed to accommodate unique settings required for very specific spatial dimensions. Spaces for reducing microbial populations on fresh produce require that the mist/fog being dispensed only travels far enough to reach across the longest dimension of the enclosure, or to reach the target fresh produce, for example. The fluid parameters adjustment may be accomplished with the air valve 102, and may be verified with an air pressure gauge also located on the front of the unit, for example.

It is a common problem of the conventional technology that excessive air pressure reduction produces mist particles that are too large to achieve a desired mist/fog profile. At the same time, particularly small spaces for decontamination often require significant air pressure reduction. These opposing constraints of a decontamination system are addressed by certain embodiments of the present disclosure. Namely, by programming the processor to control the potentiometer based on the input parameters of the spatial area for reducing microbial populations on fresh produce, a user can regulate a fluid flow rate in synchronization with the air pressure. As a result, reducing the fluid flow rate while simultaneously lowering the air pressure maintains the mist/fog particle size small, while limiting the distance the spray can reach. In this manner, the mist sprayed by the ionization/aerosalization and activation device 100 remains within the boundaries of the space for reducing microbial populations on fresh produce, without creating excessively wet and dense fog. The programmable balance between the air pressure and the fluid flow rate, therefore, prevents saturating surfaces opposite to mist applicators, increased moisture accumulation due to condensation, false negative validation results or increased aeration times of the space.

In the alternative, the device 100 can produce all of the identified benefits if manually controlled, as well. Namely, a hand-held platform of the ionization/aerosolization and activation device 100 allows operation by using a control knob on the handheld applicator to produce the ionized hydrogen peroxide mist. In certain embodiments, the device is designed to be used by technicians using a trigger on the device to control its use by adjusting the position of the trigger. In other embodiments, the operation of the device may be fully automated or semi-automated. Desired values achieved manually may be monitored on the device display

Ionization/aerosolization and activation devices/systems may be scalable and configurable to be effective in any size or volume of space/room/chamber/container. The scalability may be accomplished by the size of the device, by the manual control of the decontamination fluid, or by programming the air pressure of the device and the consequent fluid flow rate as a function of the input space/room/chamber/container parameters. Accordingly, the size and volume of the device 100 may be selected depending on the geometry of the space and the location of the target fresh produce inside the space in order to optimize reduction of microbial populations on the fresh produce.

In some embodiments, a miniature ionization/aerosolization and activation device 100 further contains a control module that allows control (v.g., start and or stop the device) and monitoring of the miniature ionization/aerosolization and activation device from a remote device such as a tablet or a phone. In other embodiments, the control module further controls data storage, transfer and printing. In certain embodiments, the control module allows for remote service and connection, for recording video or data, arid for providing feedback to the user during use or after use.

Exemplary ionization/aerosolization and activation devices/systems of the present disclosure comprise an applicator having a cold plasma arc that splits a hydrogen peroxide-based solution into reactive oxygen species, including hydroxyl radicals that seek, kill, and render pathogens inactive. The activated particles generated by the applicator kill or inactivate a broad spectrum of pathogens and are safe for sensitive equipment. In general, ionization/aerosolization and activation devices/systems of the present disclosure allow the effective treatment of an exemplary space measuring 104 m2 in about 75 minutes, including application time, contact time, and aeration time. Ionization/aerosolization and activation devices/systems of the present disclosure are scalable and configurable to be effective in any size or volume of space/room/chamber/container. Exemplary spaces include, but rue not limited to, production environments, service & technical areas, material pass-through rooms, corridors and thoroughfares. The ionization/aerosolization and activation devices/systems of the present disclosure are applicable to areas from a single space to an entire agricultural production facility. The plasma activated ionic particles generated by the present device or system ate non-caustic and silver free In general, the mist generated by the present device or system moves through an enclosed space or over a surface.

Another aspect of the present application relates to miniature ionization/aerosolization and activation devices that comprise a DCV miniature transformer and/or a DCV miniature compressor to reduce power demand and overall weight and size of the device. In some embodiments, a miniature ionization/aerosolization and activation device may be lunchbox-sized to backpack-sized, and/or has a weight in the range of 10-40 lb. In some embodiments, the miniature ionization/aerosolization and activation device is placed in a backpack, a lightweight portable case or on a wheeled cart. In certain embodiments, the device comprises a small chamber system that heats the decontamination fluid solution to cause vaporization before passing through the arc system. In particular embodiments, the device comprises a rechargeable battery operated portable wheeled system (similar in form to an IV stand-type system).

In some embodiments, the DCV miniature transformer has an input DC voltage in the range of 6-36V and generates an output of 11-22.5 kV. In some embodiments, the DCV miniature transformer has an input DC voltage of 24V and generates an output of 17.5 kV.

In some embodiments, the DCV miniature compressor provides a pressure in the range of 10-60 psi and has an input DC voltage in the range of 6-36 V. In some embodiments, the DCV miniature compressor provides a pressure in the range of 30-40 psi and has an input DC voltage of 24 V.

In some embodiments, the miniature ionization/aerosolization and activation device further comprises a diode/capacitor rectifier that smooths out arc converting process and increases the convening efficiency in AC.

In some embodiments, the miniature ionization/aerosolization and activation device further comprises low flow pump with a flow rate in the range of 4-40 ml/min and an operating voltage in the range of 6-36 VDC.

In some embodiments, the miniature ionization/aerosolization and activation device further contains a control module that allows control (e.g., start and or stop the device) and monitoring of the miniature ionization/aerosolization and activation device from a remote device such as a tablet or a phone. In some embodiments, the control module further controls data storage, transfer and printing,

In an exemplary embodiment, control of the device is through a computer system which includes a memory, a processor, and, optionally, a secondary storage device. In some embodiments, the computer system includes a plurality of processors and is configured as a plurality of, e.g., bladed servers, or other known server configurations. In particular embodiments, the computer system also includes an input device, a display device, and an output device. In some embodiments, the memory includes RAM or similar types of memory. In particular embodiments, the memory stores one or more applications for execution by the processor. In some embodiments, the secondary storage device includes a hard disk drive, floppy disk drive, CD-ROM or DVD drive, or other types of non-volatile data storage. In particular embodiments, the processor executes the applications) that are stored in the memory or the secondary storage, or received from the internet or other network. In some embodiments, processing by the processor may be implemented in software, such as software modules, for execution by computers or other machines These applications preferably include instructions executable to perform the functions and methods described above and illustrated in the Figures herein The applications preferably provide GUIs through which users may view and interact with the application(s). In other embodiments, the system comprises remote access to control and/or view the system.

The following examples are by way of illustration only and should not be considered limiting on the aspects or embodiments of the application.

### EXAMPLES

It is demonstrated herein that bacteria on the smooth surface of fresh produce items, such as apples and tomatoes, were easier to inactivate than those on rough surfaces such as tomato stem scars and cantaloupe rinds through the application of ionized hydrogen peroxide (iHP). On smooth surfaces, greater than 5 log reductions of Salmonella were achieved with a short (8-10 s) treatment time, following by a 30 min dwell time. On rough surfaces, similar treatment times resulted in 2.8-3.6 log reductions of Salmonella. Listeria appears to be more sensitive to this treatment than is Salmonella. Cold plasma and ionized/aerosolized hydrogen peroxide (H₂O₂) had unexpected synergistic effects to quickly reduce the populations of Salmonella and Listeria inoculated onto different types and surfaces of fresh produce items. Greater reductions were documented when the ionized-aerosolized hydrogen peroxide was passed through the plasma arc, confirming cold plasma enhances the activity of ionized/aerosolized hydrogen peroxide (H₂O₂) mist.

Materials and Methods

Bacterial Strains

To minimize the risk of possible bacteria becoming airborne during treatments, attenuated and non-pathogenic bacteria were used in the study. Two strains of non-pathogenic S. Typhimurium (ATCC 53647 and 53648) and three strains of L. innocua (ATCC 33090, ATCC 51742 and ATCC BAA680) were obtained from American Type Culture Collection (ATCC) (Manassas, Va., USA). Further studies used E. coli O157:H7 (ATCC 700728), S. Typhimurium (ATCC 53647 and 53648), and L. innocua (ATCC 33090) obtained from American Type Culture Collection (ATCC) (Manassas, Va., USA) and maintained as a part of the culture collection at the USDA Eastern Regional Research Center (Wyndmoor, Pa. USA). The bacteria were made to be resistant to nalidixic acid by successive growth in Trypic Soy Broth (TSB) (Difco, Sparks, Md., USA) with increasing nalidixic acid concentrations. All strains were stored at −80° C. in 1 mL of TSB containing 10% glycerol. Working cultures of S. Typhimurium and L. innocua were maintained in 9 mL TSB (supplemented with 100 μg/mL nalidixic acid for S. Typhimurium) at 4° C. after incubating at 37° C. for 40 and 45 h, respectively, and sub-cultured each time.

The S. Typhimurium strains were selected for spontaneous mutants resistant to 100 ppm of nalidixic acid by successive transfers of the bacteria into tryptic soy broth (TSB) with increasing concentrations of nalidixic acid to a final concentration 100 μg/ml over 10 days. Prior to use, stock cultures from a −80° C. freezer were inoculated info 10 ml TSB (supplemented with 100 μg/ml nalidixic acid for Salmonella) and incubated at 37° C. for 24 h. Cultures were transferred twice at 24 h intervals prior to their use in the inoculum. Strains of E. coli O157:H7, S. Typhimurium and L. innocua were separately grown in 10 ml of TSB (Difco, Sparks, Md., USA) (with 100 μg/ml nalidixic acid for Salmonella) at 37° C. for 24 h, followed by centrifugation (4000×g for 10 min at 4° C.) and washed three times with buffered peptone water (BPW; Difco). The final pellets were resuspended in sterile BPW, corresponding to approximately 8-9 log CFU/ml. S. Typhimurium strains were combined to obtain a cocktail for use in experiments.

Preparation of Inocula

Each strain of S. Typhimurium and L. innocua was cultured in 9 mL TSB (supplemented with 100 μg/mL nalidixic acid for S. Typhimurium) and incubated at 37° C. for 40 h and 48 h, respectively, harvested by centrifugation at 4000×g for 10 min at 4° C., and resuspended in 9 mL sterile Buffered Peptone Water (BPW; Difco). The pellets were resuspended in BPW to form cell suspensions with a final concentration of 108˜109 CFU/mL. Subsequently, suspended pellets of two strains of Salmonella and three strains of L. innocua were combined to obtain two separate culture cocktails.

Sample Preparation and Inoculation

Grape tomatoes, granny smith apples, romaine lettuce and cantaloupes were purchased from local markets (Philadelphia, Pa., USA) and kept at 10° C. prior to use. Fruits and vegetables were removed from 10° C. refrigeration and equilibrated to ambient temperature before being inoculated. Romaine lettuce was divided into upper green leaf and midrib tissues. Six tomatoes, six pieces (2×2 cm) of apple skins, five pieces (3×3 cm) of Romaine lettuce upper leaves, five pieces (3 cm length) of Romaine lettuce midrib area and six pieces (2×2 cm) of cantaloupe rinds with 2×3 mm thickness of flesh were used for each treatment per replicate. Bach piece w as spot inoculated with 10 μL of Salmonella and L. innocua by depositing droplets with a micropipette. The inoculated samples were dried in a bio-hood for 1 h (for tomato surfaces, romaine lettuce, apple skins and cantaloupe rinds) or 2 h (for tomato stem scars) at ambient temperature. It took a longer time for the bacteria inoculum to dry on the stem scar area of tomatoes.

Whole tomatoes, spinach and rinds of cantaloupe without prior chlorine wash or bacteria inoculation were treated with ionized/aerosolized hydrogen peroxide (H₂O₂) as described herein. The untreated (control) and treated samples were placed separately in a Stomacher bag with 20˜100 ml of neutralizing buffer and pummeled at 260 rpm for 2 mm using Stomacher (Interscience Laboratories Inc.). Decimal dilutions of the samples were made with 0.1% peptone (Difco) and aliquots (0.1 or 1 ml) were spread plated in duplicate onto TSA with incubation at 37° C. for 24 h for the enumeration of total aerobic plate count (APC), and onto Dichloran Rose Bengal Chlortetracycline (DRBC, Difco) agar with incubation at 25° C. for 5 days for enumeration of yeast and mold. DRBC plates were wrapped with aluminum foil to prevent dehydration. Experiments were conducted independently 8 times. Colonies were counted and reported as log CFU/piece.

Grape tomatoes, spinach leaves and 2×3 cm pieces of cantaloupe (with flesh) were treated with ionized/aerosolized hydrogen peroxide (H₂O₂) as described herein. lire treated samples were placed into 8 oz. clamshell containers (for tomatoes and cantaloupe pieces) or perforated film bags (for spinach) and stored at 10° C. overnight before being measured for texture and color. Experiments were repeated 8 times.

In further studies, fresh and unblemished grape tomatoes, baby spinach leaves and cantaloupes w ere purchased from local markets (Philadelphia, Pa,. USA) and stored overnight at 10° C. Fruits were removed from 10° C. and equilibrated to ambient temperature before being inoculated. Tomatoes, spinach and whole cantaloupes were sanitized with 200 ppm chlorine solutions for 2 min before being rinsed in sterilized deionized water and arranged in a single layer and air-dried for 1 h in a biohood at ambient temperature (22° C.). The chlorine pre-wash was used to reduce background microflora populations Ten tomatoes, five spinach leaves and five pieces of cantaloupe rind were used for each treatment per replicate. Pieces (2×3 cm) of cantaloupe rinds with -3 cm thickness of flesh were prepared from whole cantaloupes. The stent scar area and smooth surface of tomatoes, spinach leaves and cantaloupe rinds were inoculated with 50 μl (for cantaloupe and spinach) or 25 μl (for tomatoes) of E. coli, Salmonella and Listeria suspensions separately by depositing droplets with a micropipette at ambient temperature. Samples were dried in the bio-hood for 2 h at 22° C. with the fan running before being treated with ionized/aerosolized hydrogen peroxide (H₂O₂). Experiments were independently replicated in different times (weeks); New freshly grown inoculum, and different batch of produce items were used for each replicate.

Treatments

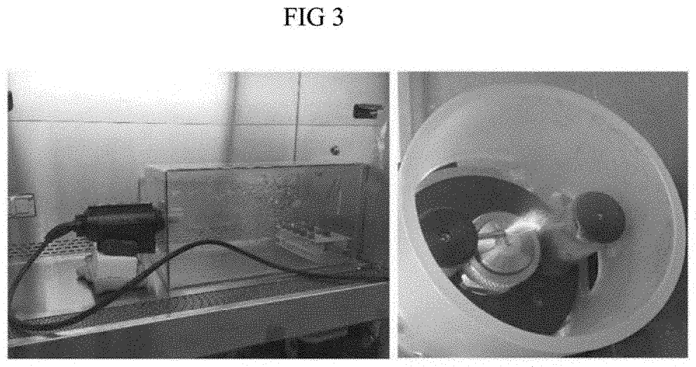

Produce items were placed onto a sterile test tube rack with the inoculated area facing up and the rack with produce pieces were placed inside of a treatment chamber (12×12×24 inch). Hydrogen peroxide (H₂O₂) (7.8%) was ionized/aerosolized into a treatment chamber using an ionization/aerosolization and activation delivering device as shown in FIG. 3. The ionized/aerosolized hydrogen peroxide (H₂O₂) was activated by cold plasma generated between two pin electrodes to create ionized hydrogen peroxide (iHP) which was applied to the produce. The flow rate for hydrogen peroxide (H₂O₂) was 5.0 mL/mm with an air pressure of 7 psi

Multiple particle detection instruments were used to monitor and characterize size distribution and number concentration of hydrogen peroxide (H₂O₂) droplets in the treatment chamber as a function of time. Specifically, a scanning mobility particle sizer (SMPS Model 3080, TSI inc., Shoreview, Minn., USA) and an aerodynamic particle sizer (APS Model 3321, TSI Inc.) were connected to the treatment chamber through an access port in the back of the treatment chamber to measure droplet sizes ranging from 2.5 to 210 nm, and from 0.5 to 20 μm, respectively. In addition, hydrogen peroxide (H₂O₂), ozone, and environmental conditions (temperature and humidity) were monitored using a gas leak detector (PortaSens II, Analytical Technology, Inc., Collegeville, Pa., USA), and Q-track (Model 8551, TSI Inc.), respectively.

In further studies, hydrogen peroxide (H₂O₂) (7.8%) was ionized/aerosolized into a treatment chamber (12×12×24 in.) containing the produce items using the iHP ionization/aerosolization and activation device (FIG. 3). Produce items were placed onto a sterile test tube tack with inoculated area facing up. As noted, the ionization/aerosolization and activation device not only aerosolizes the solution but also ionizes and activates ionized/aerosolized hydrogen peroxide (H₂O₂) as droplets pass a cold plasma field generated between two pin electrodes. The distance and voltage between the two electrodes were 9 mm and 17 kV, respectively. The flow rate for hydrogen peroxide (H₂O₂) was 9.7 ml/min with an air pressure of 15 psi. After 45 s treatment, the chamber was sealed for 30 mins (dwell time) before removal of the fresh produce items. Experiment; were repeated three times.

Size Distribution of Droplets

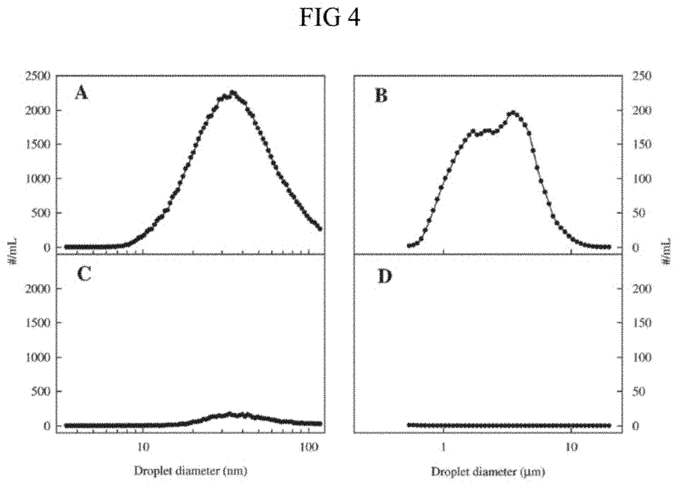

FIG. 4 shows size distribution of droplets in the treatment chamber immediately after the introduction of ionized/aerosolized hydrogen peroxide (H₂O₂) and after additional 30 min dwell time. It appears that the iHP aerosolizer introduced two size ranges of droplets into the chamber (FIGS. 4A, B): one in nanometer range and the other in micrometer range Nanosize droplets appeal ed to be polydisperse in size and followed a log normal distribution with a mean diameter of 40.3 nm, a mode (peak) of 33.4 nm and a standard deviation of 30.9 nm (geometric standard deviation 1.7). Total number of droplets in the nanosize range was 84,000 #/cc. For droplets in the micrometer range, mean diameter was 3.0 μm with a mode of 4.0 μm. About 80% of droplets were in the range of <5 μm with freaks in the range of 3.0-4.4 μm. Total number of droplets in micrometer range (0.5-20 μm) was 4390 #/cc. Due to the limitations by the utilized instrumentation there are no data available in the size range of 200-500 nm.

After 30 min (end of treatment), about 8% nanosize droplets and virtually no micrometer-size droplets remained in the treatment chamber (FIGS. 4C, D). Humidity increased from 43% to ˜90% after application of ionized aerosolized hydrogen peroxide (H₂O₂) while hydrogen peroxide (H₂O₂) concentration exceeded 150 ppm.

The results show that both nano-size and micro-size droplets were produced by the iHP aerosolizer. During the post-generation time (dwell time), the number of droplets decreased rapidly with micro-size droplets decreasing much faster than nano-size droplets. It is well known that size determines stability of droplets. The droplet size may be optimized by adjusting air/liquid flow. Some nano-water droplets showed better stability as 50% of droplets remained in treatment chamber after 4 h. The stability has been attributed to the surface charge of droplets.

A very dry mist is a mist in which particles have particle size diameter within the ranges of about 0.1-0.2 microns, 0.1-0.3 microns, 0.1-0.4 microns, 0.1-0.5 microns, 0.1-0.6 microns, 0.1-0.7 microns, 0.1-0.8 microns, 0.1-0.9 microns, 0.1-1 microns, 1-1.1 microns, 1-1.2 microns, 1-1.3 microns, 1-1.4 microns, 1-1.5 microns, 1-1.6 microns, 1-1.7 microns, 1-1.8 microns, 1-1.9 microns, 1-2 microns, 0.5-0.6 microns, 0.5-0.7 microns, 0.5-0.8 microns, 0.5-0.9 microns, 0.5-1 microns, 0.5-1.1 microns, 0.5-1.2 microns, 0.5-1.3 microns, 0.5-1.4 microns, 0.5-1.6 microns, 0.5-1.7 microns, 0.5-1.8 microns, 0.5-1.9 microns, 0.5-2 microns, 0.5-2.1 microns, 0.5-2.2 microns, 0.5-2.3 microns, 0.5-2.4 microns, 0.5-2.5 microns, 0.5-2.6 microns, 0.5-2.7 microns, 0.5-2.8 microns, 0.5-2.9 microns, 0.5-3 microns, 0.5-3.1 microns, 0.5-3.2 microns. 0.5-3.3 microns, 0.5-3.4 microns, or 0.5-3.5 microns. In certain embodiments, the very dry mist has particles with particle diameter size in the range of about 0.5-3 microns.

Effects of Treatment Time Against S. Typhimurium on Fresh Produce

For tomato surfaces and apple skins, the treatment times (spray times) were set as 5, 8 and 10 s followed by 30 min dwell time. For upper leaves and midrib tissues of Romaine lettuce, the treatment times were 10, 20, 30 and 60 s followed by 30 min dwell time. For cantaloupe rinds, the treatment times were set as 10, 30 and 60 s followed by 30 min dwell time. For tomato stem scars, the treatment procedure included 5.8, 10, 20, 30, 60 s followed by 30 min dwell time, 6 cycles composed of 10 s treatment time followed by 10 min dwell time per cycle, and 3 cycles composed of 20 s treatment time followed by 20 min dwell time per cycle. A fan (E.Z.FAN, FP-108-1, Common Wealth Industrial Corp., Taiwan) was used in the chamber to facilitate the uniform distribution of mist during dwell time.

Effect of Cold Plasma Activation on the Efficiency of Ionized Aerosolized Hydrogen Peroxide (H₂O₂) Against S. Typhimurium and L. innocua

For treatments without ionized cold plasma, the two pm electrodes were removed resulting in no ionized cold plasma generation/application to the hydrogen peroxide (H₂O₂) aerosol. Therefore, each kind of produce was treated with and without cold plasma ionized under the same optimized conditions.

Enumeration

After each treatment, the tomato stem scars and surfaces with the inoculated bacteria were removed using a pair of sterile scissors. Each type of produce item from the same treatment was combined (total weight: 1.51±0.29 g for tomato stem scars; 2.07±0.15 g for tomato surfaces; 6.37±0.92 g for apple skins; 1.62±0.34 g for Romaine lettuce upper leaves: 13.30±2.97 g for Romaine lettuce midrib tissues: 9.58±1.26 g for cantaloupe rinds) and transferred into an 80 mL filtered stomacher bag. After addition of 30 mL BBL buffered peptone water into the bag, the sample in the bag was homogenized using a mini blender (Mini Mix CC, Interscience laboratories Inc., Woburn, Mass., USA) for 2 min at a setting of 4. The homogenate (after build-in filtration) was serially diluted (if needed) and plated (0.1 mL or 1 mL depending on the treatments) onto selective media. Tryptic Soy Agar with 200 μg/mL pyruvate acid and 100 μg/mL nalidixic acid (TSA-PN) and PALCAM Agars (Difco) were used for the enumeration of S. Typhimurium and L. innocua, respectively. The plates were incubated at 37° C. for 40 and 48 h, respectively, and counted after incubation.

After treatments, the tomato smooth skin and stem scar areas with the inocula were excised using a pair of surface-sterilized scissors. The smooth skins and stem scars from five fruits treated with the same sanitizers were combined (total weight: 1.0±0.2 g for both smooth skin and stem scar) and five pieces of spinach leaves (2.4±0.4 g) were placed into stomacher bags containing 20 ml of neutralizing buffer (Difco). Five pieces of rinds of cantaloupes (20.1±6.8 g) after removal of flesh were transferred into sterile stomacher bags, containing 100 ml of neutralizing buffer (Difco). Stomacher bags were homogenized for 2 min at 260 rpm with a Stomacher (Interscience Laboratories Inc., Woburn, Mass., USA). After homogenization, filtrates were serially diluted (if needed), and aliquots (100 μl or 1 ml depending on the treatments) were spread-plated onto selective media. Sorbitol MacConkey agar (SMAC), Tryptic Soy Agar (ISA) with 100 μg/ml nalidixic acid, and PALCAM Agars (Difco) were used as selective media for the enumeration of E. coli O157:H7, S. Typhimurium, and L. monocytogenes, respectively. The plates were incubated at 37° C. for 24 h. and colonies were counted after incubation. When a sample did not yield any colonies on the plates, half the limit of detection (0.6 log CFU/piece) was used for calculation. The populations of bacteria were expressed as log CFU per piece of fruit, cantaloupe or spinach leaf.

Statistical Analysis

All experiments were repeated, and each experiment was conducted on a different day. Colony counts were converted to log CFU/piece. When no colony was present on a plate, the limit of detection was used to calculate the leg reductions The results were expressed as mean standard deviation and data were analyzed by SPSS Statistics 22 software (IBM, Amok. USA) through one-way analysis of variance (ANOVA). The P<0.05 (Duncan Multiple Range test) was used to determine statistical significance.

Experiments were repeated at least three times while multiple pieces of samples were used for each replicate as subsamples or for pooling. Statistical analyses were conducted using SAS Version 9.4 (SAS Institute Inc., Cary. N.C. USA), Treatment means and standard deviation were reported. The least significant difference test was used to test the effect of treatments with a significance level of P=0.05.

Firmness was evaluated with a TA-XT2i Texture Analyzer ( Texture Technologies Corp., Scarsdale, N.Y. USA). A 3-mm diameter probe was used to penetrate tomato fruit and cantaloupe rind to a depth of 10 mm at a speed of 10 mm/s. Five fruits/pieces were used for firmness measurements, and there were a total of 40 measurements (eight replicates). For spinach, the five leaves were placed into a Kramer cell and texture was measured with the same speed setting as for tomatoes and cantaloupe. Maximum force was recorded using the Texture Expert software (version 1.22, Texture Technologies Crop.).

Surface color of samples was measured with a Hunter UltraScan®VTS colorimeter (Hunter Associates Lab. Reston, Va., USA) using a 1.3 cm measuring aperture. D65/10° was used as the illuminant-viewing geometry. The colorimeter was calibrated using the standard black and white plates. Two readings were made on each tomato fruit and on each piece of spinach leaf (top side) and cantaloupe rind, L*, a* and b*were recorded. In addition, the appearance and offodor of the samples were assessed by three researchers.

Results and Discussion

Study 1

Hydrogen peroxide (H₂O₂) was applied as a cold plasma-ionized/activated aerosol to reduce populations of E. coli O157:H7, S. Typhimurium and L. innocua on tomato, spinach and cantaloupe rind. The results reveal that populations of E. coli O157:H7, S. Typhimurium and L. innocua inoculated on the smooth skin surface and stem scar area of tomato, spinach and cantaloupe could be significantly reduced by a 45 s ionized/aerosolized hydrogen peroxide (H₂O₂) treatment plus 30 min dwell time. The treatment resulted in N5 log CFU/piece reduction of S. Typhimurium and L. innocua and reduced E. coli to non-detectable levels on the tomato's smooth surfaces. For the three bacteria on the stem scar areas of tomatoes, the reductions were 1.0-1.3 log CFU/piece. Under the same conditions, reductions achieved on the surface of spinach leaves were 4.2 and 4.0 log CFU/leaf for Salmonella and L. innocua, respectively. On cantaloupe, the reductions were 4.9, 1.3, and 3.0 log CFU/piece for E. coli O157:H7, S. Typhimurium and L. innocua, respectively. The treatment also significantly reduced populations of native microorganisms on tomato and spinach leaves. Color and texture of the produce items were not significantly affected by the ionized/aerosolized hydrogen peroxide (H₂O₂). Overall, the results demonstrate that the ionized/aerosolized technology can be used to enhance microbial safety of fresh fruits and vegetables.

The effects of ionized/aerosolized hydrogen peroxide (H₂O₂) on E. coli O157:H7 on tomatoes, spinach leaves and cantaloupe rind are presented in Table 1. After treatment with ionized/aerosolized hydrogen peroxide (H₂O₂), the inoculated E. coil on the smooth surface of tomatoes were reduced to a level below detection limit (b0.6 log CFU/piece) while the bacterium was only reduced by 1.0 log CFU/piece on the stem scar area of tomatoes. On the surface of spinach leaves and cantaloupe rind, E. coli populations were reduced by 1.5 and 4.9 log

TABLE 1
Effects of ionized/aerosolized H₂O₂ on populations (log CFU/piece)
of E. coli O157:H7 inoculated on stem scar and smooth surface of
tomatoes, and on spinach and cantaloupes.

| | Tomato- | | | |
|---|---|---|---|---|
| | smooth | Tomato-stem | | |
| Treatments | surface | scar | Spinach | Cantaloupe |
| Control | 2.9 +/− 0.1^{a} | 3.6 +/− 0.5a | 5.1 +/− 1.0a | 6.3 +/− 0.6a |
| H₂O₂ | ND | 2.6 +/− 0.1b | 3.6 +/− 0.6b | 1.4 +/− 0.9b |

^{a}The number are means +/− standard deviations (n = 3).
^{b}Data in the same column followed by the same letter are not significantly different (P > 0.05).
^{C}ND: not detectable (detection limit: 0.6 log CFU/piece).

The populations of E. coli O157:H7 on the non-treated (control) tomato fruit were less than those on non-treated spinach and cantaloupe samples. It appears that the inoculated E. coli O157:H7 cells on the surface of tomatoes (both smooth surface and stem scar area) were less stable during the drying period after inoculation compared with those on spinach leaves and cantaloupe rinds. After 2 h of drying in a biohood after inoculation, the populations of E. coli on tomato smooth surface were 3.4 and 2.2 log less than those on cantaloupe and spinach, respectively. Overall, the results show that the ionized/aerosolized hydrogen peroxide (H₂O₂) was more effective in reducing E. coli O157:H7 on smooth surface of tomato and surface of cantaloupes than on the stem scar area of tomatoes and spinach leaves.

The extent of S. Typhimurium reductions by ionized aerosolized hydrogen peroxide (H₂O₂) depended on the types of produce (Table 2). The greatest reduction of S. Typhimurium was 5.0 log which was on the smooth surface of tomato. The same treatment achieved 4.2 log reduction of S. Typhimurium on spinach leaves. S. Typhimurium cells on cantaloupe rind and the stem scar of tomato were more difficult to inactivate, with the same treatment achieving 1.3 log reductions. Therefore, ionized/aerosolized hydrogen peroxide (H₂O₂) treatment was more effective in reducing S. Typhimurium populations on the smooth surface of tomato or spinach leaves than on the stem scar area of tomatoes or cantaloupe rind.

TABLE 2
Effects of ionized/aerosolized hydrogen peroxide (H₂O₂) on popula-
tions (log CFU/piece)of S. Typhimurium inoculated on stem scar
and smooth surface of tomatoes, and on spinach and cantaloupes.

| Treat- | Tomato-smooth | Tomato-stem | | |
|---|---|---|---|---|
| ments | surface | scar | Spinach | Cantaloupe |
| Control | 6.7 +/− 0.1^{a,b} | 7.1 +/− 0.1a | 6.7 +/− 0.1a | 6.9 +/− 0.2a |
| H₂O₂ | 1.7 +/− 1.3^{b} | 5.8 +/− 0.6b | 2.5 +/− 1.1b | 5.6 +/− 0.5b |

^{a}The number are means +/− standard deviations (n = 3).
^{b}Data in the same column followed by the same letter are not significantly different (P > 0.05).

The populations of L. innocua on the non-treated tomato's smooth surface and stem scar, spinach leaves and cantaloupe rind were 6.3, 6.2, 6.4 and 6.5 log CFU/piece, respectively (Table 3). Similar to the results on Salmonella, L. innocua cells on the smooth surface of tomato and spinach were easier to inactivate by the ionized/aerosolized hydrogen peroxide (H₂O₂), achieving approximately 6.0 and 4 0 log CFU/piece, respectively. L. innocua cells on cantaloupe and stem scar area of tomato were reduced by 3.0 and 1.3 log CFU/piece. respectively.

TABLE 3
Effects of ionized/aerosolized hydrogen peroxide (H₂O₂) on popula-
tions (log CFU/piece) of L. innocua inoculated on stem scar
and smooth surface of tomatoes, and on spinach and cantaloupes.

| Treat- | Tomato-smooth | Tomato-stem | | |
|---|---|---|---|---|
| ments | surface | scar | Spinach | Cantaloupe |
| Control | 6.3 +/− 0.2^{a} | 6.2 +/− 0.2a | 6.4 +/− 0.1a | 6.5 +/− 0.2a |
| H₂O₂ | ND^{C} | 4.9 +/− 0.4b | 2.5 +/− 1.9b | 3.5 +/− 0.2b |

^{a}The number are means +/− standard deviations (n = 3).
^{b}Data in the same column followed by the same letter are not significantly different (P > 0.05).
^{C} ND: not detectable (detection limit: 0.6 log CFU/piece).

The results indicated that E. coli O157:H7 showed greater resistance to the hydrogen peroxide (H₂O₂) treatment than S. Typhimurium on spinach, and yet lower resistance than S. Typhimurium on cantaloupe. The results from this study suggest that the hydrogen peroxide (H₂O₂) ionization/aerosolization technology may be used as an alternative to washes with common sanitizers.

The effect of ionized/aerosolized H₂O₂on APC count, and yeast and mold count on grape tomatoes, spinach leaves and cantaloupe rinds were evaluated in a further study. The APC and yeast and mold counts of untreated tomato fruits were 5.9±0.5 and 6.1±1.4 log CFU/piece, respectively (Table 4).

TABLE 4
Total aerobic plate and yeast and mold counts (Log CFU/piece) on tomato, spinach and
cantaloupe treated with and without ionized/aerosolized hydrogen peroxide (H₂O₂)

| | Total plate count | | | Yeast and mold | | |
|---|---|---|---|---|---|---|
| Treatment | Tomato | Spinach | Cantaloupe | Tomato | Spinach | Cantaloupe |
| Control | 5.9 +/− | 6.0 +/− 0.7a | 5.2 +/− 0.5a | 6.1 +/− 1.4a | 6.4 +/− 0.7a | 5.5 +/− 0.7a |
| | 0.5a^{a, b} | | | | | |
| H₂O₂ | 5.4 +/− 0.5b | 4.7 +/− 1.3b | 4.6 +/− 1.2a | 2.2 +/− 1.5b | 4.2 +/− 2.0b | 4.7 +/− 0.9a |

^{a}The number are means +/− standard deviations (n = 8).
^{b}Data in the same column followed by the same letter are not significantly different (P ≥ 0.05).

The ionized-aerosolized hydrogen peroxide (H₂O₂) treatment achieved small but statistically significant (P b 0.05) reductions (0.5, and 1.3 log, respectively) in APC of tomatoes and spinach leaves. The yeast and mold count of tomato and spinach were also significantly (P b 0.05) reduced by the ionized/aerosolized hydrogen peroxide (H₂O₂) with 3.9 and 2.2 log reductions, respectively.

Texture and color of samples were measured after 1-day storage at 10° C. There were no significant differences in texture of tomato, cantaloupe and spinach between the treated and non-treated samples (Table 5).

TABLE 5
Firmness (kg) of tomato, spinach and cantaloupe treated with
and without ionized/aerosolized hydrogen peroxide
(H₂O₂). Firmness was measured 1 day after treatment.

| Treatments | Tomato | Spinach | Cantaloupe |
|---|---|---|---|
| Control | 1.26 +/− 0.12^{a,b} | 9.52 +/− 2.19a | 5.9 +/− 1.77a |
| H₂O₂ | 1.17 +/− 0.13a | 9.87 +/− 1.94a | 6.51 +/− 0.48a |

^{a}The number are means +/− standard deviations (n = 8).
^{b}Data in the same column followed by the same letter are not significantly different (P > 0.05).

Color was expressed in terms of L*, a* and b* values, where L* values indicate luminosity (level of light or darkness); a* indicates chromaticity on a green (negative number) to red (positive number), and b* values indicate chromaticity on a blue (negative number) to yellow (positive number). L* values of tomatoes were reduced by the ionized/aerosolized treatment, indicating the darkening and less yellowing of tomato skin (Table 6). However, no visual changes were noticed. The a* values, an indication of tomato redness, were not affected by the treatment. The treatment did not significantly affect any color parameters for spinach or cantaloupe rind (Table 6). Furthermore, compared with the control, the ionized/aerosolized hydrogen peroxide (H₂O₂) did not affect the appearance or odor of the samples assessed 1 day after treatment (data not shown). In addition, the soluble solid contents of cantaloupe or tomatoes were not significantly influenced by the treatment either (data not shown). Therefore, the treatment did not have a significant impact on quality of the three produce items. In the present study, the native microflora and quality were evaluated after 1 day of storage.

TABLE 6
Color parameters of tomato, spinach and cantaloupe after being treated with and without
ionized/aerosolized hydrogen peroxide (H₂O₂). Color was measured 1 day after treatment.

| | L* | | | A* | | | B* | | |
|---|---|---|---|---|---|---|---|---|---|
| Treatments | Tomato | Spinach | Cantaloupe | Tomato | Spinach | Cantaloupe | Tomato | Spinach | Cantaloupe |
| Control | 33.29 +/− | 34.66 +/− | 64.32 +/− | 23.30 +/− | −8.37 +/− | 3.12 +/− | 20.28 +/− | 17.81 +/− | 28.89 +/− |
| | 0.75a^{a, b} | 1.58a | 1.26a | 1.79a | 0.24a | 0.39a | 0.94a | 0.76a | 0.91a |
| H₂O₂ | 32.41 +/− | 33.71 +/− | 64.16 +/− | 22.88 +/− | −8.13 +/− | 2.54 +/− | 19.77 +/− | 17.70 +/− | 28.80 +/− |
| | 0.64b | 1.47a | 1.55a | 0.67a | 0.25a | 0.66a | 0.94a | 0.75a | 1.19a |

^{a}The number are means +/− standard deviations (n = 8).
^{b}Data in the same column followed by the same letter are not significantly different (P > 0.05).

Study 2

The conditions were optimized for the cold plasma-activated ionized/aerosolized hydrogen peroxide (H₂O₂) treatment for the inactivation of Salmonella Typhimurium on four types of fresh produce items The study investigated whether cold plasma activation affected the efficacy of ionized/aerosolized hydrogen peroxide against S. Typhimurium and L. innocua. Stem scars and smooth surfaces of grape tomatoes, surfaces of granny smith apples and romaine lettuce (both midrib and upper leaves) and cantaloupe rinds were inoculated with two-strain cocktails of S. Typhimurium and 3-strain cocktails of L. innocua. The inoculated samples were treated with 7.8% ionized/aerosolized hydrogen peroxide (H₂O₂) with and without cold plasma for various times. On the smooth surfaces of tomatoes and apples, an 8 s treatment followed by 30 min dwell time achieved more than 5 log CFU/piece reduction of Salmonella. On other fresh produce items, the treatment, when applied for a longer time period, achieved up to a 3.6 log reduction of Salmonella. For all fresh produce items and surfaces, cold plasma significantly (P<0.05) improved the efficacy of ionized/aerosolized hydrogen peroxide (H₂O₂) against Salmonella and L. innocua. Without cold plasma activation, hydrogen peroxide (H₂O₂) aerosols only reduced populations of Salmonella by 1.54-3.17 log CFU/piece while hydrogen peroxide (H₂O₂) with cold plasma achieved 2.35-5.50 log CFU/piece reductions of Salmonella. I. innocua was more sensitive to the cold plasma-ionized/activated hydrogen peroxide (iHP) than Salmonella. Cold plasma, ionized hydrogen peroxide (H₂O₂) aerosols reduced listeria populations by more than 5 log CFU/piece on all types and surfaces of fresh produce except for the tomato stem scar area. Without cold plasma, the reductions by H₂O₂ were only 1.35-3.77 log CFU/piece.

The effects of treatment time of ionized hydrogen peroxide (ionized/aerosolized hydrogen peroxide (H₂O₂) treated with cold plasma) against S. Typhimurium on grape tomatoes, granny smith apples, romaine lettuce and cantaloupes are shown in Tables 7-12. Based on these results, it can be concluded that ionized hydrogen peroxide Is very effective in inactivating bacteria on the smooth surfaces of tomato and apple fruits ( Tables 7 and 8). After an 8 s treatment time, the population of inoculated S. Typhimurium was reduced to a level below the detection limit (0.70 log CPU/piece). There was no significant difference between 8 s and 10 s treatment times on the reductions of S. Typhimurium. Therefore, the 8 s treatment time followed by 30 min dwell time was chosen as the optimal treatment condition for smooth surfaces of tomatoes and

TABLE 7
Effects of treatment time on populations (log CFU/piece) of S.
Typhimurium inoculated on grape tomato surfaces with cold plasma.

| Treatment | Populations (log CFU/piece) | | Reductions (log |
|---|---|---|---|
| time(s) | Control | treated | CFU/piece) |
| 5 | 6.28 ± 0.19^{a} | 4.44 ± 0.25^{a} | 1.84 ± 0.43^{b} |
| 8 | 5.91 ± 0.49^{a} | ND^{b} | 5.21 ± 0.49^{a} |
| 10 | 6.35 ± 0.21^{a} | ND^{b} | 5.65 ± 0.21^{a} |

^{a}Means followed by the same letters in the same column are not significantly different (Duncan Multiple Range test, P = 0.05). Numbers are averages ± standard deviations (n = 3).
^{b}ND: not detectable (detection limit: 0.70 log CFU/piece).

TABLE 8
Effects of treatment time on populations (log CFU/piece) of S.
Typhimurium inoculated on Granny Smith apple skins with cold plasma.

| Treatment | Populations (log CFU/piece) | | Reductions (log |
|---|---|---|---|
| time(s) | Control | treated | CFU/piece) |
| 5 | 5.72 ± 0.48^{a} | 4.09 ± 0.13^{a} | 1.63 ± 0.35^{b} |
| 8 | 5.88 ± 0.19^{a} | ND^{b} | 5.18 ± 0.19^{a} |
| 10 | 5.56 ± 0.58^{a} | ND^{b} | 4.86 ± 0.58^{a} |

^{a}Means followed by the same letters in the same column are not significantly different (Duncan Multiple Range test, P = 0.05). Numbers are averages ± standard deviations (n = 3).
^{b}ND: not detectable (detection limit: 0.70 log CFU/piece).

TABLE 9
Effects of treatment time on populations (log CFU/piece) of S.
Typhimurium inoculated on grape tomato stem scars with
cold plasma. The 10s^{×}6 refers to 6 cycles of 10 s spray
time followed by 10 min dwell time while 20s^{×}3 refers
3 cycles of 20 s spray time with 20 min dwell time.

| Treatment | Populations (log CFU/piece) | | Reductions (log |
|---|---|---|---|
| time(s) | Control | treated | CFU/piece) |
| 5 | 5.32 ± 0.71^{c} | 4.26 ± 0.89^{ab} | 1.06 ± 0.35^{d} |
| 8 | 5.45 ± 0.58^{bc} | 4.23 ± 0.31^{ab} | 1.22 ± 0.28^{d} |
| 10 | 5.46 ± 0.57^{bc} | 4.26 ± 0.71^{ab} | 1.20 ± 0.14^{d} |
| 20 | 6.22 ± 0.30^{ab} | 4.71 ± 0.26^{ab} | 1.51 ± 0.34^{cd} |
| 30 | 6.17 ± 0.22^{ab} | 4.31 ± 0.20^{a} | 1.85 ± 0.11^{bc} |
| 60 | 6.01 ± 0.24^{abc} | 3.85 ± 0.66^{ab} | 2.16 ± 0.43^{b} |
| 10s × 6 | 6.08 ± 0.32^{abc} | 3.89 ± 0.39^{ab} | 2.19 ± 0.41^{b} |
| 20s × 6 | 6.33 ± 0.15^{a} | 3.60 ± 0.42^{b} | 2.73 ± 0.28^{a} |

Means followed by the same letters in the same column are not significantly different (Duncan Multiple Range test, P = 0.05). Numbers are averages ± standard deviations (n = 3).

S. Typhimurium on stem scars of grape tomato was inactivated at lower rates than those on the smooth surface of tomatoes (Table 9). A 5 s treatment only reduced Salmonella populations by 1.06 log CFU/piece. As the treatment time increased, the greater reductions were generally achieved. However, even after 60 s treatment, the reduction was only 2.16 log CFU/g. Therefore, ionized hydrogen peroxide was repeatedly applied in bursts for a total of 60 s treatment time to optimize efficacy. Three cycles of 20 s spray time plus 20 min dwell time proved to be the most effective application to reduce S. Typhimurium populations on the stem scar, achieving a 2.73 log CFU/piece reduction. Therefore. 20 s spray time followed by 20 min dwell time was chosen as the optimum condition to reduce the bacteria on tomato stem scars.

For the two tissues of romaine lettuce. Salmonella on midrib tissues proved easier to inactivate by ionized hydrogen peroxide compared to those on the upper leaf, with reductions increasing with longer treatment times on both types of tissues (Tables 10 and 11) The 20 s treatment time significantly reduced the populations of inoculated S. Typhimurium on both tissues. With spray time extended to 30 s, the reductions were 2.86 and 3.63 log CFU/piece on the upper leaf and midrib tissue respectively. No additional significant increases in inactivation were achieved when the spray time was increased to 60 s. Considering the efficiency of the operation, 30 s treatment time followed by 30 min dwell time was regarded as the optimized condition for romaine lettuce.

TABLE 10
Effects of treatment time on populations (log CFU/piece) of S.
Typhimurium inoculated on Romaine lettuce midrib
area with cold plasma.

| Treatment | Populations (log CFU/piece) | | Reductions (log |
|---|---|---|---|
| time(s) | Control | treated | CFU/piece) |
| 10 | 6.34 ± 0.37^{a} | 4.81 ± 0.22^{a} | 1.53 ± 0.23^{c} |
| 20 | 6.12 ± 0.30^{a} | 4.09 ± 0.25^{b} | 2.04 ± 0.33^{b} |
| 30 | 6.17 ± 0.41^{a} | 2.54 ± 0.32^{c} | 3.63 ± 0.21^{a} |
| 60 | 6.07 ± 0.59^{a} | 2.94 ± 0.18^{c} | 3.13 ± 0.48^{a} |

Means followed by the same letters in the same column are not significantly different (Duncan Multiple Range test, P = 0.05). Numbers are averages ± standard deviations (n = 3).

TABLE 11
Effects of treatment time on populations (log CFU/piece) of S.
Typhimurium inoculated on Romaine lettuce leaves
with cold plasma.

| Treatment | Populations (log CFU/piece) | | Reductions (log |
|---|---|---|---|
| time(s) | Control | treated | CFU/piece) |
| 10 | 6.24 ± 0.23^{a} | 5.45 ± 0.34^{a} | 0.79 ± 0.16^{c} |
| 20 | 5.95 ± 0.39^{a} | 3.98 ± 0.37^{b} | 1.98 ± 0.24^{b} |
| 30 | 6.40 ± 0.16^{a} | 3.54 ± 0.11^{b} | 2.86 ± 0.17^{a} |
| 60 | 6.36 ± 0.38^{a} | 3.57 ± 0.25^{b} | 2.79 ± 0.20^{a} |

Means followed by the same letters in the same column are not significantly different (Duncan Multiple Range test, P = 0.05). Numbers are averages ± standard deviations (n = 3).

TABLE 12
Effects of treatment time on populations (log CFU/piece) of S.
Typhimurium inoculated on cantaloupe rinds
with cold plasma.

| Treatment | Populations (log CFU/piece) | | Reductions (log |
|---|---|---|---|
| time(s) | Control | treated | CFU/piece) |
| 10 | 5.89 ± 0.13^{b} | 4.39 ± 0.32^{a} | 1.50 ± 0.21^{b} |
| 30 | 6.57 ± 0.56^{a} | 4.09 ± 0.24^{a} | 2.48 ± 0.68^{a} |
| 60 | 5.68 ± 0.07^{b} | 3.23 ± 0.28^{b} | 2.44 ± 0.32^{a} |

Means followed by the same letters in the same column are not significantly different (Duncan Multiple Range test, P = 0.05). Numbers are averages ± standard deviations (n = 3).

For Salmonella on the rind of the cantaloupe, after 30 s of treatment, the population of the bacterium was reduced by 2.48 log CFU/piece. The 60 s treatment failed to achieve greater reductions compared to the 30 s treatment. Therefore, 30 s treatment time followed by 30 min dwell time was the best condition for reducing the bacteria inoculated onto cantaloupe rinds.

The conditions were optimized to achieve maximum reductions of Salmonella on apple, tomatoes, romaine lettuce and cantaloupe. Results indicated that a very short treatment time (8 sec) was enough to reduce the bacterial populations by mote than 5 logs on the smooth surface of apples and tomatoes.

These results demonstrate ionized hydrogen peroxide (H₂O₂) aerosol run through a cold plasma ate (iHP) provides unexpected enhanced efficacy against bacteria on various fresh produce. In the present study, the advanced oxidation process was applied in the ionized/aerosolized phase; reducing the droplet size of the mist also facilitates the diffusion of the ionized/aerosolized hydrogen peroxide (H₂O₂) to rough surfaces.

After establishing the optimum conditions for the inactivation of Salmonella, and demonstrating that cold plasma-ionized/activated hydrogen peroxide (H₂O₂) reduced populations of Salmonella by 2.48 to >5 log CFU/piece (depending on type and nature of produce), whether cold plasma played any role in the hydrogen peroxide (H₂O₂) inactivation of Salmonella and Listeria was studied. Results revealed that cold plasma significantly enhanced the efficacy of ionized/aerosolized hydrogen peroxide (H₂O₂) on all produce items (Table 13). For example, without cold plasma activation, the reduction of Salmonella populations were only 3.17 and 2.08 log CFU/piece on smooth surface of tomatoes and apples, respectively, while the reductions were more than 5 logs when the ionized/aerosolized hydrogen peroxide (H₂O₂) passed through a cold plasma arc (iHP process).

TABLE 13
Cold plasma activation on the efficacy of ionized/aerosolized hydrogen peroxide (H₂O₂) in
inactivating Salmonella Typhimurium on various fresh produce surfaces. Treatment
conditions: 8 s spray time followed by 30 min dwell time for Granny Smith apple and tomato
smooth surface; 30 s spray time followed by 30 min dwell time for upper leaf and midrib
tissues of Romaine lettuce and cantaloupe rind; three cycles of 20 s spray time plus 20 min
dwell time for tomato stem scar.

| | Populations (log CFU/piece) | | | Reductions (log CFU/piece) | |
|---|---|---|---|---|---|
| Type of | | H₂O₂ − cold | H₂O₂ + cold | H₂O₂ − cold | H₂O₂ + cold |
| produce | Control | plasma | plasma | plasma | plasma |
| Granny Smith | 5.85 ± 0.15^{a} | 3.77 ± 0.17^{b} | ND^{c} | 2.08 ± 0.17^{y} | 5.50 ± 0.19^{x} |
| apples | | | | | |
| Romaine | 6.42 ± 0.20^{a} | 4.70 ± 0.23^{b} | 3.54 ± 0.11^{c} | 1.72 ± 0.23^{y} | 2.88 ± 0.11^{x} |
| lettuce-upper | | | | | |
| leaf | | | | | |
| Romaine | 5.94 ± 0.41^{a} | 4.16 ± 0.28^{b} | 2.54 ± 0.32^{c} | 1.78 ± 0.28^{y} | 3.40 ± 0.32^{x} |
| lettuce-midrib | | | | | |
| Cantaloupe rind | 6.37 ± 0.43^{a} | 4.83 ± 0.36^{b} | 3.76 ± 0.53^{c} | 1.54 ± 0.36^{y} | 2.61 ± 0.53^{x} |
| Tomato-surface | 5.63 ± 0.46^{a} | 2.46 ± 0.33^{b} | ND^{c} | 3.17 ± 0.33^{y} | 5.28 ± 0.49^{x} |
| Tomato-stem scar | 5.95 ± 0.40^{a} | 4.40 ± 0.28^{b} | 3.60 ± 0.70^{c} | 1.54 ± 0.28^{y} | 2.35 ± 0.30^{x} |

ND: not detectable (detection limit: 0.70 log CFU/piece)
Means followed by the same letters in the same row for population (a, b, c) or reduction (x, y) are not significantly different (Duncan Multiple Range test, P = 0.05). Numbers are averages ± standard deviations (n = 3).

The same treatment conditions were used with and without cold plasma to inactivate L. innocua on the same type of produce items. Results demonstrated that, without cold plasma, reductions of L. innocua populations ranged from 1.35 on the stern scar of tomatoes to 3.77 log CFU/piece on romaine lettuce midribs. When the iHP process of running the ionized/aerosolized hydrogen peroxide (H₂O₂) aerosols through the plasma arc was applied. Listeria populations were reduced by more than 5 logs for all types of fresh produce and surfaces except for the stem scar area of tomatoes, on which only 2.36 log CFU/piece reduction (Table 8). Significantly higher reductions of Listeria were achieved by the plasma activated hydrogen peroxide (H₂O₂) process on romaine lettuce and cantaloupes than Salmonella.

There is an unexpected synergistic effect between cold plasma and ionized/aerosolized hydrogen peroxide (H₂O₂) in the iHP process that maximizes pathogen reduction, The reductions of Salmonella by the cold plasma-activated water were 0.93±0.45, 0.85±0.16, 0.53±0.08, 0.23±0.35, 1.03±0.04, 0.37±0.06 log CFU/piece, and the reductions of Listeria were 0.37±0.02. −0.01±0.18, 0.22±0.06, 0.28±0.16, 0.40±0.20, 0.12±0.15 log CFU/piece on granny smith apple surface, romaine letter upper leaf, romaine letter lower midrib, cantaloupe rind, tomato smooth surface and tomato stem scar, respectively. The results show that cold-plasma treated water had very limited effectiveness in reducing populations of Salmonella and Listeria on fresh produce. Ionized/aerosolized hydrogen peroxide (H₂O₂) aerosols without cold plasma reduced the populations of Salmonella by 1.53-3.17 log CFU/piece and Listeria by 1.35-3,77 log CFU/piece on various fresh produce items. However, when cold plasma was applied to aerosolized H2O2 in the iHP process, the reductions of Salmonella were 2.35-5.50 log CFU/piece and Listeria reductions were more than 5 log CFU/piece on all produce items except tomato stem scar (Tables 13 and 14).

The results demonstrate that cold plasma enhanced the effectiveness of ionized/aerosolized hydrogen peroxide (H₂O₂) against the inoculated bacteria on all tested produce items and surfaces. Without being bound by theory, the combination of cold plasma and H₂O₂ initiates an advanced oxidation process, producing hydroxyl radicals. Furthermore, electrically charging increases the stability of free radicals in the nanometer sized droplets; nanometer sized droplets were more stable than micrometer sized ones.

The results demonstrated that L. innocua, a Gram-positive bacterium, was more sensitive to the cold plasma-activated hydrogen peroxide (H₂O₂). More than a 5 log reduction of Listeria was observed on all fresh produce items except the stem scar area of tomatoes, while the Listeria reductions were 2.61 to 3.40 log CFU/piece for cantaloupes and two locations on lettuces (Table 14). The cell envelope of Gram-negative bacteria is composed of a multilayer system with an inner cytoplasmic membrane made of phospholipids and proteins, a peptidoglycan layer, and an outer membrane of polymers such as polysaccharides Gram-positive bacteria have a thicker peptidoglycan layer and only one layer of cytoplasmic membrane. The reactive species generated from the advanced oxidation process herein (hydroxyl radicals) penetrate better into the single membrane of Grain-positive bacteria. Bactericidal effects of reactive species such as hydroxyl radicals were due to peroxidation of phospholipids and lipoproteins found in the inner membrane of both Gram-negative and Gram-positive cells.

TABLE 14
Cold plasma activation on the efficacy of ionized/aerosolized (H₂O₂) in
inactivating Listeria innocua on various fresh produce surfaces. Treatment
conditions: 8 s spray time followed by 30 min dwell time for Granny Smith apple and tomato
smooth surface; 30 s spray time followed by 30 min dwell time for upper leaf and midrib
tissues of Romaine lettuce and cantaloupe rind; three cycles of 20 s spray time plus 20 min
dwell time for tomato stem scar.

| | Populations (log CFU/piece) | | | Reductions (log CFU/piece) | |
|---|---|---|---|---|---|
| Type of | | H₂O₂ − cold | H₂O₂ + cold | H₂O₂ − cold | H₂O₂ + cold |
| produce | Control | plasma | plasma | plasma | plasma |
| Granny Smith | 5.59 ± 0.25^{a} | 2.90 ± 0.20^{b} | ND1^{c} | 2.69 ± 0.20^{y} | 5.24 ± 0.22^{x} |
| apple | | | | | |
| Romaine | 5.57 ± 0.23^{a} | 2.80 ± 0.34^{b} | ND2^{c} | 2.77 ± 0.34^{y} | 5.19 ± 0.08^{x} |
| lettuce-upper | | | | | |
| leaf | | | | | |
| Romaine | 5.59 ± 0.23^{a} | 1.82 ± 0.35^{b} | ND2^{c} | 3.77 ± 0.35^{y} | 5.21 ± 0.11^{x} |
| lettuce-midrib | | | | | |
| Cantaloupe rind | 5.45 ± 0.26^{a} | 3.88 ± 0.37^{b} | ND1^{c} | 1.57 ± 0.37^{y} | 5.10 ± 0.30^{x} |
| Tomato-surface | 5.51 ± 0.28^{a} | 2.77 ± 0.21^{b} | ND1^{c} | 2.74 ± 0.21^{y} | 5.16 ± 0.20^{x} |
| Tomato-stem scar | 5.57 ± 0.25^{a} | 4.21 ± 0.60^{b} | 2.94 ± 0.89^{c} | 1.35 ± 0.60^{y} | 2.62 ± 0.89^{x} |

ND: not detectable (detection limit: 0.70 log CFU/piece ND1, 0.76 log CFU/piece ND2).
Means followed by the same letters in the same row for population (a, b, c) or reduction (x, y) are not significantly different (Duncan Multiple Range test, P = 0.05). Numbers are averages ± standard deviations (n = 3).

Bacteria on the smooth surface of fresh produce items such as apples and tomatoes were easier to inactivate than those on rough surfaces such as tomato stem scars and cantaloupe rinds through the application of ionized hydrogen peroxide (iHP). On smooth surfaces, greater than 5 log reductions of Salmonella were achieved with a short (8-10 s) treatment time, following by a 30 min dwell time. On rough surfaces, similar treatment times resulted in 2.8-3.6 log reductions of Salmonella. Listeria appears to be more sensitive to this treatment than is Salmonella. Cold plasma and aerosolized hydrogen peroxide (H₂O₂) had unexpected synergistic effects to quickly reduce the populations of Salmonella and Listeria inoculated onto different types and surfaces of fresh produce items. Greater reductions were documented when the ionized/aerosolized hydrogen peroxide was passed through the plasma arc, showing cold plasma unexpectedly enhances the activity of hydrogen peroxide (H₂O₂) mist.

While various embodiments have been described above, it should be understood that such, disclosures have been presented by way of example only and are not limiting. Thus, the breadth and scope of the subject compositions and methods should not be limited by any of the above-described exemplary embodiments. The above description is for the purpose of teaching the person of ordinary skill in the an how to practice the present invention, and it is not intended to detail all those obvious modifications and variations of it which will become apparent to the skilled worker upon reading the description. It is intended, however, that all such obvious modifications and variations can be included within the scope of the present application as defined by the embodiments described herein.

What is claimed is;

1. A method for reducing microbial populations on fresh produce, comprising the steps of:
entering input parameters of a space containing fresh produce into a processing unit, wherein the processing unit is programmed to determine fluid properties of a decontamination fluid in an ionization/aerosolization and activation device based on the input parameters of the space containing fresh produce,
activating a decontamination cycle of the ionization/aerosolization and activation device, wherein the decontamination cycle comprises the steps of:
providing a reservoir of the decontamination fluid;
setting the determined fluid properties of the decontamination fluid;
generating a very dry mist comprising ionized hydrogen peroxide of the decontamination fluid, wherein an ionized/aerosolized mist of hydrogen peroxide is passed through a cold plasma arc;
applying the generated very dry mist to surfaces on the fresh produce within the space containing the fresh produce.

2. The method of claim 1, further comprising operating the ionization/aerosolization and activation device manually.

3. The method of claim 2, wherein the ionization/aerosolization and activation device is hand-held to be operated manually.

4. The method of claim 1, wherein the input parameters of the space containing fresh produce comprise: dimensions of the space containing fresh produce, a position of the ionization/aerosolization and activation device relative to boundaries of the space containing fresh produce, air temperature, pressure, and humidity of the space containing fresh produce

5. The method of claim 1, wherein the set fluid properties of the decontamination fluid comprise air pressure and fluid flow rate.

6. The method of claim 1, wherein the setting of the determined fluid properties to the decontamination fluid is performed by controlling an air valve.

7. The method of claim 6, wherein the air valve is controlled by programming the processing unit to control a potentiometer

8. The method of claim 1, wherein the determined fluid properties of the decontamination fluid are adjusted by a size and a shape of a tube located at an exit of the decontamination fluid out of the ionization/aerosolization and activation device.

9. The method of claim 1, wherein at least 80% the very dry mist comprises particles of diameter size in the range of under 5 microns.

10. The method of claim 5, wherein the fluid properties of the decontamination fluid are set by lowering the air pressure and the fluid flow rate respectively below a predetermined standard air pressure and a predetermined standard fluid flow rate.

11. The method of claim 1, further comprising:
entering input parameters of a space containing fresh produce into a processing unit, wherein the processing unit is further programmed to determine the fluid properties of the decontamination fluid in the ionization/aerosolization and activation device based on the input parameters of the small enclosure

12. The method of claim 11, wherein the very dry mist comprises polydisperse particles in the nanosized range of mean diameter 40.3 nm, a mode of 33.4 nm and a standard deviation of 30.9 nm.

13. The method of claim 1, wherein the input parameters of the space containing fresh produce are manually input.

14. The method of claim 1, wherein the input parameters of the space containing fresh produce are measured by a plurality of sensors that are in networked communication with the processing unit.

15. The method of claim 1, wherein the processing unit and the ionization/aerosolization and activation device are in wireless communication.

16. A system for decontaminating a space containing fresh produce, comprising a ionization/aerosolization and activation device and a computer processor, wherein the computer processor is in networked communication with the ionization/aerosolization and activation device,
wherein input parameters of the space containing fresh produce are entered into the computer processor,
wherein the computer processor is programmed to determine fluid properties of a decontamination fluid in the ionization/aerosolization and activation device based on the input parameters of the space containing fresh product.
wherein the computer processor is further programmed to activate a decontamination cycle of the ionization/aerosolization and activation device, the decontamination cycle comprising the steps of:
providing a reservoir of the decontamination fluid;
setting the determined fluid properties of the decontamination fluid:
generating a very dry mist comprising ionized hydrogen peroxide of the decontamination fluid, wherein an ionized/aerosolized mist of hydrogen peroxide is passed through a cold plasma arc;
applying the generated very dry mist to decontaminate the space containing fresh produce.

17. The system of claim 16, wherein the ionization/aerosolization and activation device is operated manually.

18. The system of claim 17, wherein the ionization/aerosolization and activation device is hand-held to be operated manually.

19. The system of claim 16, wherein the input parameters of the space containing fresh produce comprise-dimensions of the space containing fresh produce, a position of die ionization/aerosolization and activation device relative to boundaries of the space containing fresh produce, air temperature, pressure, and humidity of the space containing fresh produce.

20. The system of claim 16, wherein the set fluid properties of the decontamination fluid comprise air pressure and fluid flow rate.
